(19) United States
(12) Patent Application Publication
(10) Pub. No.: US 2013/0341539 A1
(43) Pub. Date: Dec. 26, 2013

(54) VALVE APPARATUS

(71) Applicants: Jim Hughes, Martin (AU); Dale Parker, Rockingham (AU)

(72) Inventors: Jim Hughes, Martin (AU); Dale Parker, Rockingham (AU)

(21) Appl. No.: 13/989,290

(22) PCT Filed: Nov. 24, 2011
(86) PCT No.: PCT/AU11/01514

§ 371 Date: Sep. 6, 2013

(30) Foreign Application Priority Data
Nov. 24, 2010 (AU) 2010905195

(51) Int. Cl. E21B 33/06; F16K 11/06; E21B 34/14

(52) U.S. Cl. CPC E21B 33/063; E21B 34/14; F16K 11/06
USPC 251/1.3; 137/876

(57) ABSTRACT

A valve apparatus (100) for a well comprises a valve body (101), and a valve member (102). The valve body (101) includes a first passage (190) that extends through the valve body (101), and at least one second passage (193) that extends through the valve body and laterally from the first passage (190). The valve body (101) being connectable to the well so that a fluid flowing from the well is able to flow through the first passage (190). The valve member (102) being insertable into the first passage (190) and being moveable relative to the valve body (101) so as to thereby control the flow of the fluid from the first passage (190) into each second passage (193).

### FIELD OF THE INVENTION

The present invention relates generally to valve apparatus for controlling the flow of a fluid from a well.

Although the present invention will be described with particular reference to being used to control the flow of crude oil and/or natural gas from a well, it will be appreciated that it is not necessarily limited to this particular use.

### BACKGROUND ART

A blowout in the context of well drilling is the uncontrolled release of crude oil and/or natural gas from an oil well or gas well after pressure control systems have failed.

There have recently been a number of oil well blowouts. On 21 Aug. 2009 the West Atlas oil rig was involved in a blowout that occurred in the Timor Sea off the coast of Western Australia. Another blowout which resulted in the destruction and sinking of the Deepwater Horizon oil rig occurred in the Gulf of Mexico on 20 Apr. 2010.

Both the Timor Sea blowout and the Gulf of Mexico blowout resulted in the uncontrolled release of large quantities of crude oil and natural gas into the surrounding environment. The release of this crude oil and natural gas has been quite harmful to the surrounding environments as well as to the wildlife inhabiting those environments.

When drilling a well, a large specialised valve called a “blowout preventer” or “BOP” is normally used to cope with extreme erratic pressures and uncontrolled flow (formation kick) emanating from a well reservoir, and for preventing well blowouts. In addition to controlling the downhole pressure and the flow of oil and gas, blowout preventers are intended to prevent tubing (e.g. drill pipe and well casing), tools and drilling fluid from being blown out of the wellbore when a blowout threatens. Blowout preventers are critical to the safety of crew, rig, and the environment, and to the monitoring and maintenance of well integrity. Consequently, blowout preventers are intended to be fail-safe devices.

Although blowout preventers are intended to be fail-safe devices, they nevertheless do occasionally fail. If a blowout preventer fails, it can be very difficult to regain control over the flow of oil and/or gas from the well. During the period that control is lost, a large quantity of oil and/or gas from the well may flow into the surrounding environment.

Even if a blowout preventer successfully prevents a blowout from occurring, the sudden increase in pressure in the well that is caused by the operation of the blowout preventer can damage the well and also the geological formation in which the well has been drilled. In some cases, the damage to the well and the formation can be severe enough that oil and/or gas is/are able to escape from the well and flow into the formation. The escaped oil and/or gas may then find its way into the environment through geological fissures and the like.

It is against this background that the present invention has been developed.

### SUMMARY OF THE INVENTION

It is an object of the present invention to overcome, or at least ameliorate, one or more of the deficiencies of the prior art mentioned above, or to provide the consumer with a useful or commercial choice.

Other objects and advantages of the present invention will become apparent from the following description, taken in connection with the accompanying drawings, wherein, by way of illustration and example, various preferred embodiments of the present invention are disclosed.

According to a first broad aspect of the present invention, there is provided a valve apparatus for a well, the apparatus comprising a valve body, and a valve member, the valve body including a first passage that extends through the valve body, and at least one second passage that extends through the valve body and laterally from the first passage, the valve body being connectable to the well so that a fluid flowing from the well is able to flow into the first passage and into each second passage from the first passage, the valve member being insertable into the first passage and being moveable relative to the valve body so as to thereby control the flow of the fluid from the first passage into each second passage.

Preferably, the valve apparatus is for an oil and/or gas well. It is particularly preferred that the valve apparatus is for a subsea oil and/or gas well.

Preferably, each second passage is inclined relative to the first passage.

Preferably, the valve body also includes a valve seat for engaging with the valve member.

Preferably, the valve apparatus also includes an O-ring seal mounted on the valve member such that the O-ring seal is able to form a seal between the valve body and the valve member. In a preferred form, the valve member includes a first shoulder, the valve body includes a second shoulder, and the O-ring seal is supported on the first shoulder and is able to engage with the second shoulder when the valve member is inserted into the first passage so that the O-ring seal thereby forms a seal between the valve member and the valve body.

In one preferred form, the valve apparatus also includes a seal that is secured to a lower end of the valve member such that the seal is able to form a seal between the valve member and the valve seat.

In another preferred form, the valve apparatus also includes an O-ring seal mounted on the valve body such that the seal is able to form a seal between a lower end of the valve member and the valve body.

Preferably, the valve member includes a profiled end for engaging with the valve seat.

In a preferred form, the valve member is able to be moved relative to the valve body by moving the valve member along the first passage. In an alternative preferred form, the valve member is able to be moved relative to the valve body by rotating the valve member relative to the valve body.

Preferably, the valve member includes a third passage that extends through the valve member such that the fluid is able to flow from the first passage and into the third passage.

Preferably, the valve apparatus also includes a valve member cap for securing to the valve member such that an end of the third passage is sealed by the valve member cap.

In one preferred form, the valve apparatus also includes a threaded shank fixedly secured to the valve member cap, a rod including an internally threaded end that the threaded shank is screwed in to such that the rod can be extended and retracted relative to the shank by rotating the shank relative to the rod, a flange secured to the rod and located adjacent an opposite end of the rod to the shank, and a seal supported by the flange, the valve seat including a recess for receiving the opposite end of the rod, the valve member cap being rotatable relative to the valve member such that the seal is able to sealingly engage the valve member and the valve seat and such that the opposite end of the rod is able to sealingly engage with the recess so that the fluid flowing into the first passage is thereby able to be prevented from flowing past the valve seat.

Preferably, the valve body also includes at least one fourth passage extending through the valve body and laterally from the first passage so that at least some of the fluid that flows into the first passage is able to be diverted to flow from the first passage into each fourth passage, and the valve apparatus also including at least one fine shut down valve for controlling the flow of the fluid from each fourth passage.

Preferably, the valve apparatus also includes at least one valve for controlling the flow of the fluid from each second passage.

Preferably, the valve apparatus also includes a valve body cap for securing to the valve body such that an end of the first passage is sealed by the valve body cap.

Preferably, the valve apparatus also includes a pipe cutter for cutting a pipe that extends through the first passage of the valve body and through the third passage of the valve member such that the pipe is able to be cut by the pipe cutter below each second passage into a bottom part and a top part, at least one lower grab ram for holding the bottom part of the cut pipe relative to the valve body, and at least one upper grab ram for holding the top part of the cut pipe relative to the valve member.

Preferably, the valve apparatus also includes at least one shear ram for shearing the pipe.

Preferably, the valve apparatus also includes a fold shear for capping the pipe.

Preferably, the valve apparatus also includes a lower frame for securing to an outlet of the well, and an upper frame for securing to the valve body, the lower frame including a plurality of upstanding posts, and the upper frame include a plurality of collars for receiving the upstanding posts such that the valve body is thereby able to be aligned with the outlet.

Preferably, the valve apparatus also includes a valve operable to seal the third passage of the valve member after a pipe is withdrawn from the third passage.

Preferably, the valve body is able to be connected to the well such that the valve body is able to function as a wellhead of the well. For example, the valve body may be secured to a casing of the well such that the valve body is thereby connected to the well and is able to function as a wellhead of the well.

Preferably, the valve apparatus also includes a clamp for securing the valve member to the valve body. It is preferred that the clamp is located inside the first passage of the valve body. In a particular preferred form, the clamp includes a H4 locking system.

Preferably, the valve apparatus also includes at least one pump connected to each second passage. It is preferred that each pump is an electric over hydraulic pump.

In a first preferred form, the valve apparatus also includes a blowout preventer, and the valve member is part of the blowout preventer. Preferably, the valve apparatus also includes a riser package connected to the blowout preventer. Preferably, the valve apparatus also includes a riser connected to the riser package.

In a second preferred form, the valve apparatus also includes a riser package, and the valve member is part of the riser package. Preferably, the valve apparatus also includes a blowout preventer connected to the valve body. Preferably, the valve apparatus also includes a riser connected to the riser package.

In a third preferred form, the valve apparatus also includes a riser, and the valve member is part of the riser. Preferably, the valve apparatus also includes a riser package connected to the valve body. Preferably, the valve apparatus also includes a blowout preventer connected to the riser package.

In a fourth preferred form, the valve apparatus also includes a riser string that includes a plurality of interconnected risers, the valve member is part of one of the risers, and the valve body is connected to another one of the risers. Preferably, the valve apparatus also includes a riser package connected to one of the risers. Preferably, the valve apparatus also includes a hinged clamp that connects the riser package to the riser string. Preferably, the valve apparatus also includes a blowout preventer connected to the riser package.

Preferably, the valve apparatus also includes at least one hydraulic cylinder secured to the valve body and to the valve member, each hydraulic cylinder being operable to move the valve member relative to the valve body. It is preferred that each hydraulic cylinder is built-in to the valve body. It is also preferred that each hydraulic cylinder is secured to one of the valve body and the valve member by a sacrificial connector so that the valve member is able to be released from the valve body by breaking the sacrificial connector. In one preferred form, the sacrificial connector that secures each hydraulic cylinder to one of the valve body and the valve member is a shear pin. In another preferred form, the sacrificial connector that secures each hydraulic cylinder to one of the valve body and the valve member is a stud.

Preferably, the valve member includes a diffuser that is located at a lower end of the valve member and that is able to protect at least one of the valve body and the valve member from wear.

Preferably, the valve body also includes at least one flow dynamic altering region that is able to alter the flow dynamics of the fluid so as to assist the fluid to be diverted to flow from the first passage and into each second passage of the valve body.

Preferably, the valve apparatus also includes a platform that is connected to the valve member and that is operable to move the valve member relative to the valve body. In one preferred form the platform is a vessel. In another preferred form the platform is a well rig. It is preferred that the valve member is able to be moved relative to the valve body by varying the buoyancy of the platform.

Preferably, the valve apparatus also includes a tensioner that is connected to the valve member and that is operable to move the valve member relative to the valve body.

Preferably, the valve member includes an upper part and a lower part secured to the upper part by at least one sacrificial connector so that the lower part of the valve member is able to be released from the upper part of the valve member by breaking each sacrificial connector, the valve apparatus also includes at least one hydraulic pump that is able to operatively engage with the lower part after the valve member has been withdrawn from the first passage of the valve body by a predetermined distance and that is able to be operated by further withdrawing the valve member from the first passage so that each sacrificial connector breaks and the lower part releases from the upper part, at least one hydraulically operated lock that is operable by the pump to substantially maintain the position of the withdrawn and released lower part relative to the valve body, and a blind shear ram operable by the pump to seal a wellbore of the well.

Preferably, each sacrificial connector that secures the lower part to the upper part is a shear pin.

Preferably, each hydraulic pump is a hydraulic cylinder pump.

Preferably, each hydraulically operated lock includes a locking pin for engaging with the lower part.

Preferably, the valve apparatus also includes a pipe junction for diverting the fluid flowing from the well after the wellbore is sealed by the blind shear ram.

Preferably, the valve apparatus also includes a flex joint connected to the valve member, and a riser connected to the flex joint.

Preferably, the valve apparatus also includes at least one hydraulically operated first valve that is connected to each second passage and that is operable by the pump to control the flow of the fluid from each second passage, and at least one hydraulically operated second valve that is connected to the pipe junction and that is operable by the pump to control the flow of the fluid from a lateral passage of the pipe junction.

Preferably, the valve apparatus also includes at least one valve connecting the hydraulic pump to each hydraulically operated lock.

Preferably, the valve apparatus also includes at least one valve connecting the pump to each first valve and to each second valve.

Preferably, the valve apparatus also includes at least one hydraulic accumulator connected to the pump, the blind shear ram, each hydraulically operated lock, each first valve, and to each second valve.

Preferably, the valve apparatus also includes a plurality of shear jaws that are hinged to the valve body and that are operable to shear through a pipe that is connected to the well and that extends through the first passage of the valve body, and the valve member includes a plurality of cams that are able to operably engage with the shear jaws after the valve member has been partially withdrawn from the first passage of the valve body such that the shear jaws are able to pivoted so that they shear through the pipe without shearing through the valve member and such that further withdrawal of the valve member causes the cams to pivot the shear jaws so that the shear jaws are able to shear through the pipe.

According to a second broad aspect of the present invention, there is provided a method for controlling a fluid flowing from a well, the method comprising the steps of:

connecting the valve body of an apparatus according to the first broad aspect of the present invention to the well so that the fluid flowing from the well is able to flow into the first passage of the valve body and into each second passage of the valve body from the first passage; and

moving the valve member of the valve apparatus relative to the valve body so as to control the flow of the fluid into each second passage from the first passage.

In a preferred form, the step of moving the valve member relative to the valve body includes moving the valve member along the first passage. In an alternative preferred form, the step of moving the valve member of the valve apparatus relative to the valve body includes rotating the valve member relative to the valve body.

According to a third broad aspect of the present invention, there is provided a diverter apparatus for a well, the apparatus comprising a body, the body including a first passage that extends through the body, and at least one second passage that extends through the body and laterally from the first passage, and a cap for securing to the body such that an end of the first passage is sealed by the cap, the body being connectable to the well so that a fluid flowing from the well is able to flow into the first passage and into each second passage from the first passage.

Preferably, the diverter apparatus is for an oil and/or gas well. It is particularly preferred that the diverter apparatus is for a subsea oil and/or gas well.

Preferably, the diverter apparatus also includes at least one valve for controlling the flow of the fluid from each second passage.

Preferably, the diverter apparatus also includes at least one pump connected to each second passage. It is preferred that each pump is an electric over hydraulic pump.

### BRIEF DESCRIPTION OF THE DRAWINGS

In order that the invention may be more fully understood and put into practice, a preferred embodiment thereof will now be described with reference to the accompanying drawings, in which:

FIG. 1 is a perspective view of a first preferred embodiment of a valve apparatus mounted on a mock-up of a flanged pipe outlet;

FIG. 2 is a perspective view of the first part of the valve body of the valve apparatus illustrated in FIG. 1;

FIG. 3 is a perspective view of the second part of the valve body of the valve apparatus illustrated in FIG. 1;

FIG. 4 is a perspective view of the bore of the second part of the valve body illustrated in FIG. 3;

FIG. 5 is a perspective view of the valve body of the valve apparatus illustrated in FIG. 1 mounted on the mock-up flanged pipe outlet;

FIG. 6 is a perspective view of the valve member of the valve apparatus illustrated in FIG. 1;

FIG. 7 is a perspective view that depicts the valve member cap of the valve apparatus illustrated in FIG. 1 partially mounted on the valve member of the apparatus;

FIG. 8 is a perspective view of the mock-up flanged pipe outlet on which the valve body of the valve apparatus illustrated in FIG. 1 is mounted;

FIG. 9 is a perspective view of a ball valve that may be used to control the flow of fluid from a second passage of the valve body illustrated in FIG. 1;

FIG. 10 is a cross-sectional side elevation of an alternative valve member and a side elevation of an alternative valve member cap when the cap is not engaged with the valve member;

FIG. 11 depicts the valve member and the valve member cap illustrated in FIG. 10 after securing the cap to the valve member and after securing the piston rod of a hydraulic cylinder of the valve apparatus to the valve member;

FIG. 12 is a side elevation of an alternative valve body second part, an alternative valve member, and a hydraulic cylinder for moving the valve member relative to the valve body;

FIG. 13 is a partial cross-sectional side elevation of part of a second preferred embodiment of a valve apparatus;

FIG. 14 is a cross-sectional side elevation of part of the valve member, a seal mounted on the end of the valve member, and part of the valve body first part of the valve apparatus depicted in FIG. 13;

FIG. 15 is a plan view of the valve body of the valve apparatus depicted in FIG. 13 which depicts the various supports, pins, and bolts for securing the hydraulic cylinders of the apparatus relative to the valve body and the valve member;

FIG. 16 is a partial cross-sectional side elevation of part of a third preferred embodiment of a valve apparatus;

FIG. 17 is a partial cross-sectional side elevation of part of a fourth preferred embodiment of a valve apparatus;

FIG. 18 is a partial cross-sectional side elevation of part of a fifth preferred embodiment of a valve apparatus;

FIG. 19 is a partial cross-sectional side elevation of part of a sixth preferred embodiment of a valve apparatus;

FIG. 20 depicts an alternative support for securing a hydraulic cylinder relative to a valve body flange;

FIG. 21 is a plan view of a valve body and a plurality of the supports illustrated in FIG. 20 secured to the valve body;

FIG. 22 is a plan view of a valve body that includes a plurality of alternative supports for supporting a hydraulic cylinder;

FIG. 23 depicts the support illustrated in FIG. 22 in further detail as well as a pin and R-clip;

FIG. 24 is a partial cross-sectional side elevation of a seventh preferred embodiment of a valve apparatus;

FIG. 25 is a partial cross-sectional side elevation of an eighth preferred embodiment of a valve apparatus;

FIG. 26 is a partial cross-sectional side elevation of part of a ninth preferred embodiment of a valve apparatus;

FIG. 27 is a side elevation of a hydraulic cylinder of the valve apparatus depicted in FIG. 26;

FIG. 28 is a fragmentary cross-sectional elevation of the valve body wall of the valve apparatus depicted in FIG. 26;

FIG. 29 depicts an inner surface of part of a valve body wall of the valve apparatus illustrated in FIG. 26;

FIG. 30 is a partially exploded perspective view of a tenth preferred embodiment of a valve apparatus;

FIG. 31 is a top perspective view of part of the valve apparatus depicted in FIG. 30 following assembly of the valve apparatus;

FIG. 32 is a side perspective view of part of the valve apparatus depicted in FIG. 30 following assembly of the valve apparatus;

FIG. 33 is a side perspective view of part of the assembled valve apparatus depicted in FIG. 32 following extension of the valve member relative to the valve body;

FIG. 34 is a side elevation of an eleventh preferred embodiment of a valve apparatus;

FIG. 35 is a side elevation of a valve member of an auto close valve depicted in FIG. 34;

FIG. 36 is a front view of the valve member depicted in FIG. 35;

FIG. 37 is another view of the valve member depicted in FIG. 35;

FIG. 38 is a partial cross-sectional side elevation of the auto close valve depicted in FIG. 34;

FIG. 39 is a partial cross-sectional side elevation of a twelfth preferred embodiment of a valve apparatus;

FIG. 40 is a partial cross-sectional side elevation of a thirteenth preferred embodiment of a valve apparatus;

FIG. 41 is a partial cross-sectional side elevation of a fourteenth preferred embodiment of a valve apparatus;

FIG. 42 is a partial cross-sectional side elevation of a fifteenth preferred embodiment of a valve apparatus which depicts the flow dynamics of a fluid flowing through the valve body;

FIG. 43 is a partial cross-sectional side elevation of a sixteenth preferred embodiment of a valve apparatus;

FIG. 44 is a partial cross-sectional side elevation of a seventeenth preferred embodiment of a valve apparatus;

FIG. 45 is a partial cross-sectional side elevation of an eighteenth preferred embodiment of a valve apparatus;

FIG. 46 is a plan view of a first set of closed shear jaws that may be incorporated into the valve apparatus illustrated in FIG. 45;

FIG. 47 is a cross-sectional side elevation of the engaged edges of a second set of shear jaws when the shear jaws are closed;

FIG. 48 is a cross-sectional side elevation of the edges of third set of shear jaws when the shear jaws are closed;

FIG. 49 is a side elevation of a fourth set of shear jaws when the shear jaws are shearing through a pipe; and

FIG. 50 is a side elevation of a fourth set of shear jaws when the shear jaws are shearing through a pipe.

### BEST MODE(S) FOR CARRYING OUT THE INVENTION

In the drawings, like features of the various preferred embodiments have been referenced with like reference numbers.

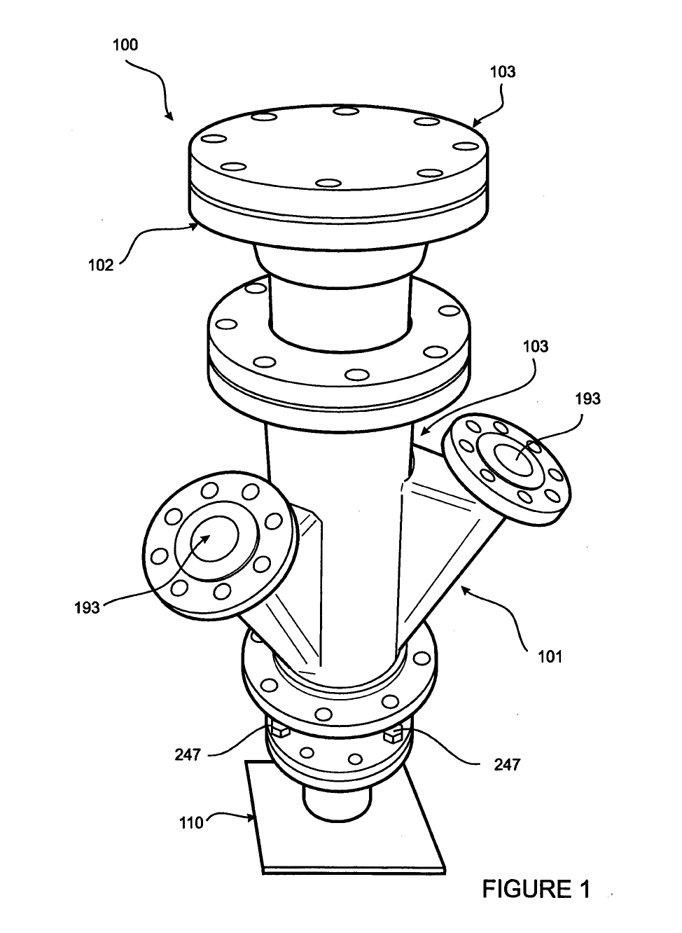

Referring to FIG. 1, a first preferred embodiment of a valve apparatus 100 for controlling the flow of oil or gas from a well such as, for example, a subsea well, includes a valve body 101, a valve member 102, and a valve member cap 103. The valve 100 is shown mounted on a mock-up of a flanged pipe outlet 104.

The valve body 101, valve member 102, and the cap 103 each comprise a plurality of separate parts that are secured together. In other preferred embodiments, the valve body 101, valve member 102, or the cap 103 may be formed as a single piece. For example, the valve body 101, valve member 102, or the cap 103 may be cast as a single piece.

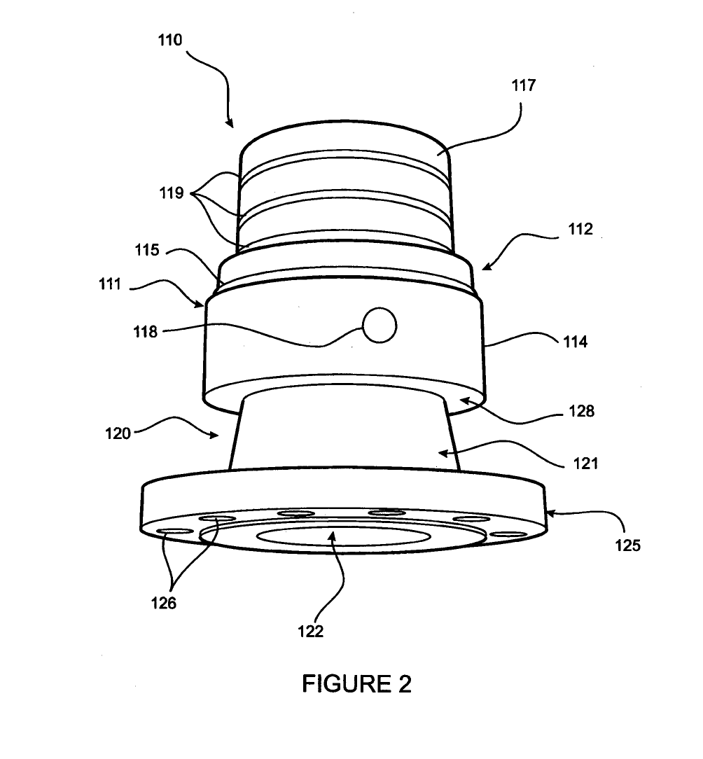

Referring to FIG. 2, the valve body 101 includes a first part 110. The first part 110 includes a pipe 111. A wall 112 of the pipe 111 defines a bore 113 (see FIG. 4) of the pipe 111. Wall 112 includes a first cylindrical section 114, a truncated conical section 115, a second cylindrical section 116, and a third cylindrical section 117. The second cylindrical section 116 has a diameter that is less than the diameter of the first cylindrical section 114. The third cylindrical section 117 has a diameter that is less than the diameter of the second cylindrical section 116. A plurality of fourth passages/holes 118 extend through the first cylindrical section 114 of the wall 112 to the bore 113. A plurality of grooves 119 extend around the circumference of the third cylindrical section 117. A respective O-ring seal (not depicted) is mounted in each groove 119.

First part 110 also includes a tapered or conical pipe 120. A wall 121 of the pipe 120 defines a bore 122 of the pipe 120. The narrower end of the pipe 120 is inserted into an end of the bore 113 of the pipe 111. A weld 123 secures the pipes 111, 120 to each other, and also forms a seal that is able to prevent fluid from leaking out between the pipes 111, 120.

A circular flange 125 is welded to the pipe 120 such that the flange 125 is located adjacent to the wider end of the pipe 120. A plurality of circumferentially-spaced holes 126 extends through the flange 125.

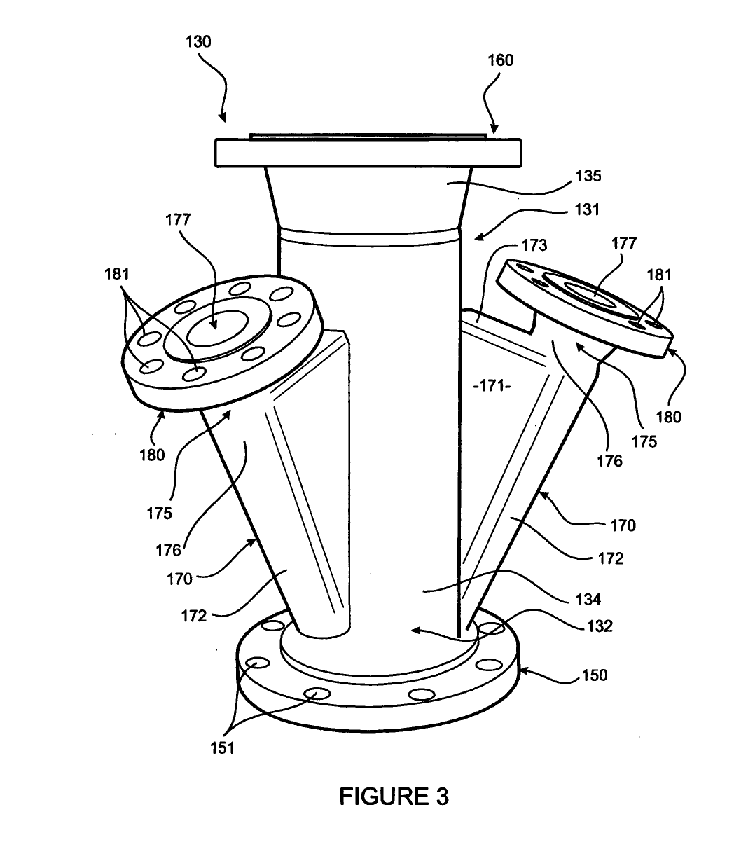

Referring to FIG. 3, the valve body also includes a second part 130. The second part 130 includes a pipe 131. A wall 132 of the pipe 131 defines a bore 133 (see FIG. 4) of the pipe 131. Wall 132 includes a cylindrical section 134, and a truncated conical section 135.

With reference to FIG. 4, a plurality of inlet openings/holes 136 and 137 extend through the cylindrical section 134 of the wall 132. Holes 136 are larger than the holes 137. The holes 136, 137 are arranged into three identical circumferentially-spaced groups 138. Each group 138 includes six holes 136, and five holes 137 on either side of the holes 136.

A circular flange 150 is welded to the pipe 131 such that the flange 150 is located adjacent to a lower end of the pipe 131. A plurality of circumferentially-spaced holes 151 extends through the flange 150.

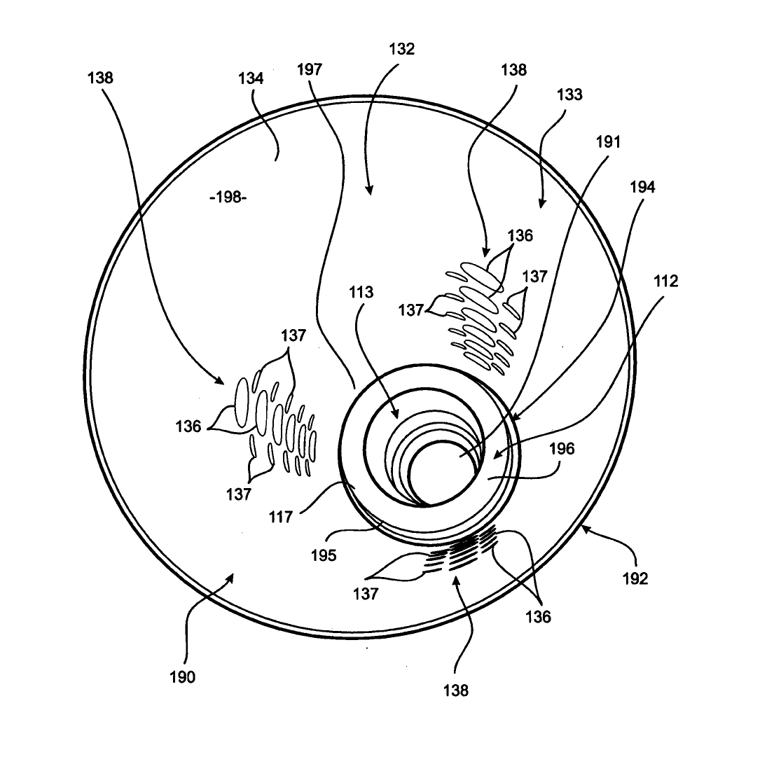

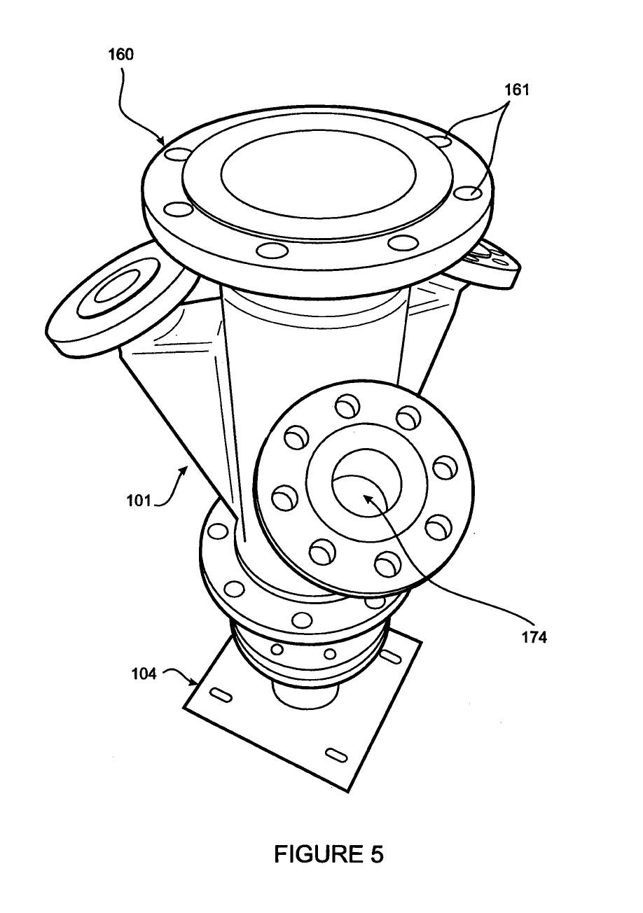

A circular flange 160 is welded to the pipe 131 such that the flange 160 is located adjacent to an upper end of the pipe 131. A plurality of circumferentially-spaced holes 161 (see FIG. 5) extends through the flange 160.

Three hollow housings 170 are welded to the pipe wall 132. Each housing 170 has a pair of laterally-spaced triangular side walls 171, a rectangular front wall 172 that extends between the side walls 171, and an end wall 173 that also extends between the side walls 171. Each housing 170 is positioned over a respective one of the hole groups 138, and is then welded to the wall 132 along a respective edge of each of the side walls 171, front wall 172, and end wall 173 of the housing 170 such that the wall 132 as well as the housing 170 define a chamber 174 (see FIG. 5). Fluid is able to flow from the bore 133 and into each chamber 174 through the inlet openings/holes 136, 137.

Each housing 170 has a short length of pipe 175 welded to it. Each pipe 175 includes a wall 176 that defines an outlet opening/bore 177. The pipes 175 are welded to the housings 170 such that fluid is able to flow out of the chambers 174 and through the pipes 175.

A respective circular flange 180 is welded to each pipe 175 such that the flange 180 is located adjacent to an upper end of the pipe 175. A plurality of circumferentially-spaced holes 181 extends through each flange 180.

Referring again to FIG. 1, the valve body 101 is constructed from the first part 110 and the second part 130 by mounting the second part 130 on the first part 110 such that pipe 111 of the first part 110 is inserted into the lower end of the bore 133 of the pipe 131. The diameter of the second cylindrical section 116 is slightly less than the diameter of the bore 133 so that the second cylindrical section 116 and the third cylindrical section 117 are able to be inserted into the bore 133. The diameter of the first cylindrical section 114 of the pipe 111 is greater than the diameter of the bore 133 so that it cannot be inserted into the bore 133, and so that the lower end of the second part 130 rests against the truncated conical section 115 of the pipe 111. After insertion into the bore 133, pipe 111 is welded to the second part 130 such that fluid is unable to leak out of the valve body 101 from between the flange 150 and the pipe wall 112.

Referring again to FIG. 4, the bore 113 of the pipe 111, the bore 122 of the pipe 120, and the bore 133 of the pipe 131 collectively form a central first passage 190 of the valve body 101. The first passage 190 extends through the body 101, and has a first end 191 into which fluid is able to flow from the outlet 104, and a second end 192 from which the fluid is able to flow from the first passage 190 and the body 101.

Referring once more to FIG. 1, the valve body 101 also includes a plurality of lateral second passages 193 that extend through the body 101 from a side of/laterally from the first passage 190 so that a fluid that flows into the first passage 190 is able to flow into the second passages 193 from the first passage 190. Each second passage 193 is formed by/includes the inlet openings/holes 136, 137 of a respective one of the hole groups 138, a respective one of the chambers 174 connected to each of those inlet opening/holes 136, 137, and a respective one of the outlet openings/bores 177 that is connected to the chamber 174. Fluid is able to flow from the first passage 190 and into each second passage 193 through the inlet openings/holes 136, 137, and then an out of the second passage 193 and the valve body 101 through the outlet openings/bores 177.

Referring again to FIG. 4, the valve body 101 also includes a valve seat 194 for engaging with the valve member 102. Seat 194 includes an outer surface 195 of the third cylindrical pipe wall section 117, and an end surface 196 of the second cylindrical pipe wall section 116. The outer surface 195 is spaced apart from the pipe wall 132 by an annular gap 197. Outer surface 195 is parallel to an inner surface 198 of the pipe wall 132. End surface 196 is perpendicular with respect to the inner surface 198.

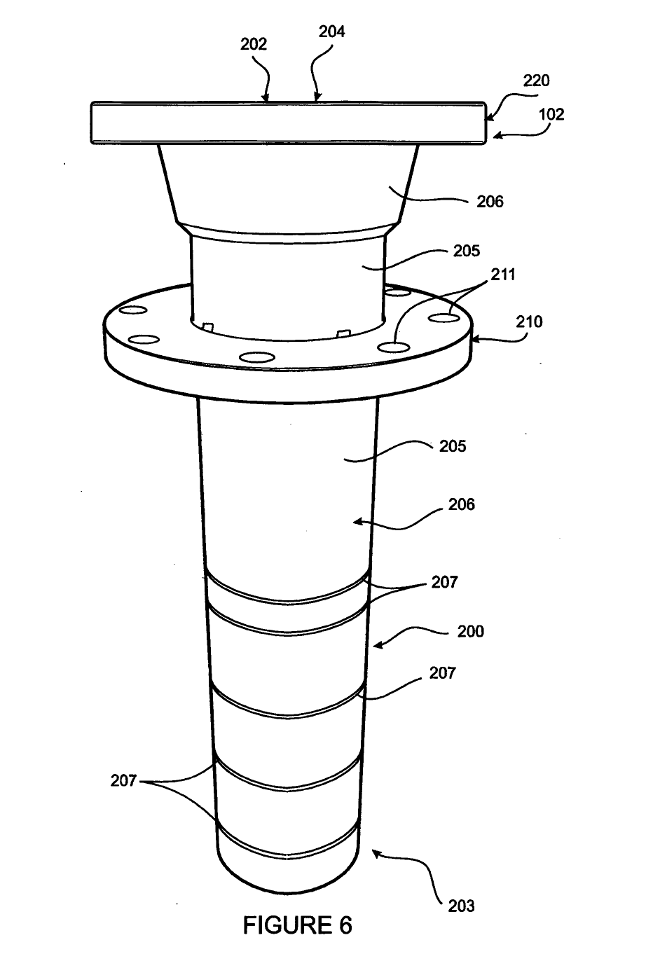

Referring to FIG. 6, the valve member 102 includes a pipe 200. A wall 201 of the pipe 200 defines a bore/third passage 202 of the pipe 200. Bore 202 has a first end 203, and a second end 204. Wall 201 includes a cylindrical section 205, and a truncated conical section 206. A plurality of grooves 207 extend around the circumference of the cylindrical section 205. A respective O-ring seal (not depicted) is mounted in each groove 207.

A circular flange 210 is welded to the cylindrical section 205 of the pipe wall 201. A plurality of circumferentially-spaced holes 211 extends through the flange 210.

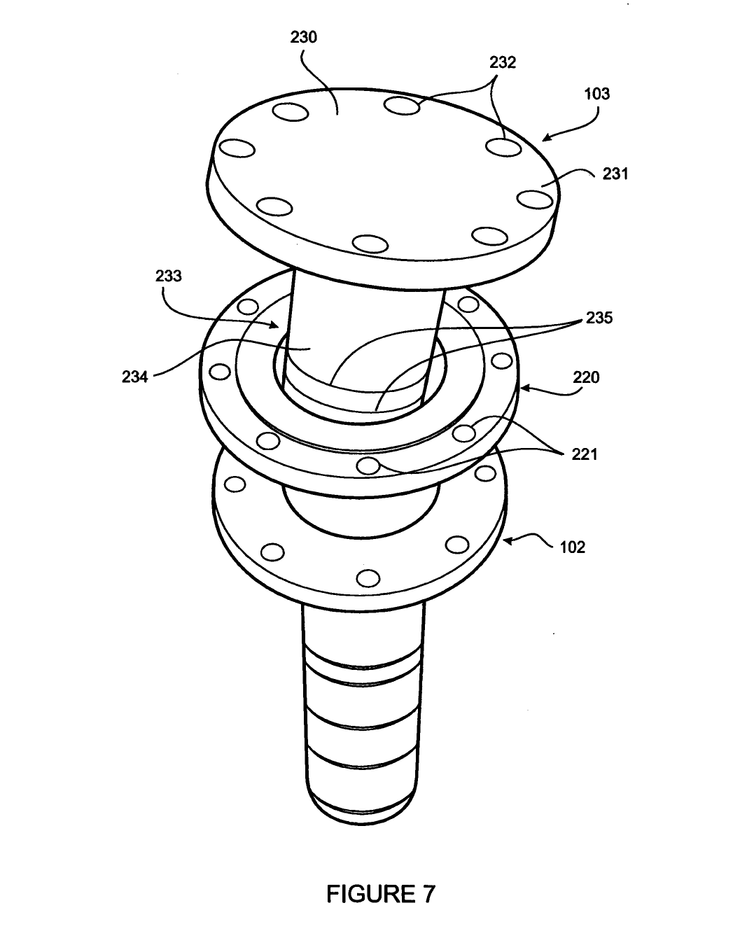

A circular flange 220 is welded to the truncated conical section 206 of the pipe wall 201. A plurality of circumferentially-spaced holes 221 (see FIG. 7) extends through the flange 220.

The diameter of the cylindrical wall section 205 is slightly less than the diameter of the bore 133 of the pipe 131 so that the cylindrical section 205 is able to be inserted into the bore 133 through the second end 192 of the first passage 190, and so that the pipe 200 and, hence, the valve member 102, is able to be moved relative to the valve body 101 by moving it back and forth along the bore 133 and, hence, the first passage 190.

Fluid is able to flow from the first passage 190 of the valve body 101 into the first end 203 of the valve member third passage 202, and is then able to flow out of the second end 204 of the valve member third passage 202.

The O-ring seals that are mounted in the grooves 207 of the pipe wall 201 form a seal between an outer surface of the wall 201 and the inner surface 198 of the pipe wall 132 so that fluid is thereby prevented from leaking out of the valve apparatus 100 from between the pipe 200 and the pipe 131.

The valve member 102 is able to be moved along the first passage 190 of the valve body 101 to such an extent that a seal is able to be formed between the valve member 102 and the valve seat 194. In particular, a seal is able to be formed between an inner surface of the pipe wall 201 and the O-ring seals that are mounted in the grooves 119 of the third cylindrical pipe wall section 117, and also between an end of the pipe wall 201 and another O-ring seal (not depicted) that may be mounted on the pipe 111 such that the O-ring seal rests on top of the end surface 196. The seal that is formed between the valve member 102 and the valve seat 194 in this way is able to prevent fluid from flowing from the first passage 190 into each second passage 193.

The rate at which fluid is able to flow from the first passage 190 into each second passage 193 is able to be varied by adjusting the extent to which the pipe 200 is inserted into the bore 133. The further the pipe 200 is inserted into the bore 133, the lower the rate at which fluid is able to flow from the first passage 190 into each second passage 193 and then out of the valve body 101 from the second passages 193. Conversely, the further the pipe 200 is withdrawn from the bore 133, the higher the rate at which fluid is able to flow from the first passage 190 into each second passage 193 and then out of the valve body 101 from the second passages 193. The reason that varying the extent to which the pipe 200 is inserted into or withdrawn from the bore 133 is able to vary the rate of flow of fluid from the first passage 190 into each second passage 193 is because doing so varies the number of holes 136, 137 in each group 138 that the fluid is able to flow through. Increasing the number of holes 136, 137 in each group 138 that the fluid is able to flow through, increases the rate at which the fluid is able to flow from the first passage 190 into each second passage 193. Decreasing the number of holes 136, 137 in each group 138 that the fluid is able to flow through, decreases the rate at which the fluid is able to flow from the first passage 190 into each second passage 193.

If the valve member 102 is fully inserted into the first passage 190 so that it engages with the valve seat 194, fluid is prevented from flowing from the first passage 190 and into the second passages 193. Consequently, all of the fluid will only flow through the first passage 190.

Valve apparatus 100 may also include a plurality of hydraulic rams/cylinders (not depicted) for moving the valve member 102 back and forth along the first passage 190 of the valve body 101. The hydraulic cylinders are able to control the extent to which the pipe 200 is inserted into the bore 133, and therefore the rate at which fluid is able to flow from the first passage 190 into each second passage 193 and then out of the valve body 101 from the second passages 193.

Fine shut down taps/valves (not depicted) that are connected to the holes 118 may be operated to control the flow of fluid from the holes 118. The taps/valves may be opened to allow fluid from the first passage 190 into and then out of the holes 118. Alternatively, the taps/valves may be closed to prevent fluid from the first passage 190 from flowing out of the holes 118.

Referring to FIG. 7, the cap 103 includes a plate 230 that has or provides a circular flange 231. A plurality of circumferentially-spaced holes 232 extends through the flange 231. A pipe 233 is welded to the plate 230. A cylindrical wall 234 of the pipe 233 defines a bore/passage (not depicted) of the pipe 233. A plurality of grooves 235 extends around the circumference of the wall 234. A respective O-ring seal (not depicted) is mounted in each groove 235.

Pipe 233 has a diameter that is less than the diameter of the valve member bore/passage 202 so that the pipe 233 is able to be inserted into the passage 202. After the pipe 233 has been fully inserted into the passage 202, the cap 103 can be secured to the valve member 102 by: aligning the holes 221 in the flange 220 with the holes 232 in the flange 231; inserting a respective bolt (not depicted) into each pair of aligned holes; screwing a respective nut (not depicted) onto each bolt; and then tightening each nut. The O-ring seals that are mounted in the grooves 235 of the pipe wall 234 form a seal between an inner surface of the pipe wall 201 and an outer surface of the pipe wall 234 so that fluid is thereby prevented from leaking out of the second end 204 of the passage 202. In this way, the cap 103 is able to seal the second end 204 of the valve member passage 202.

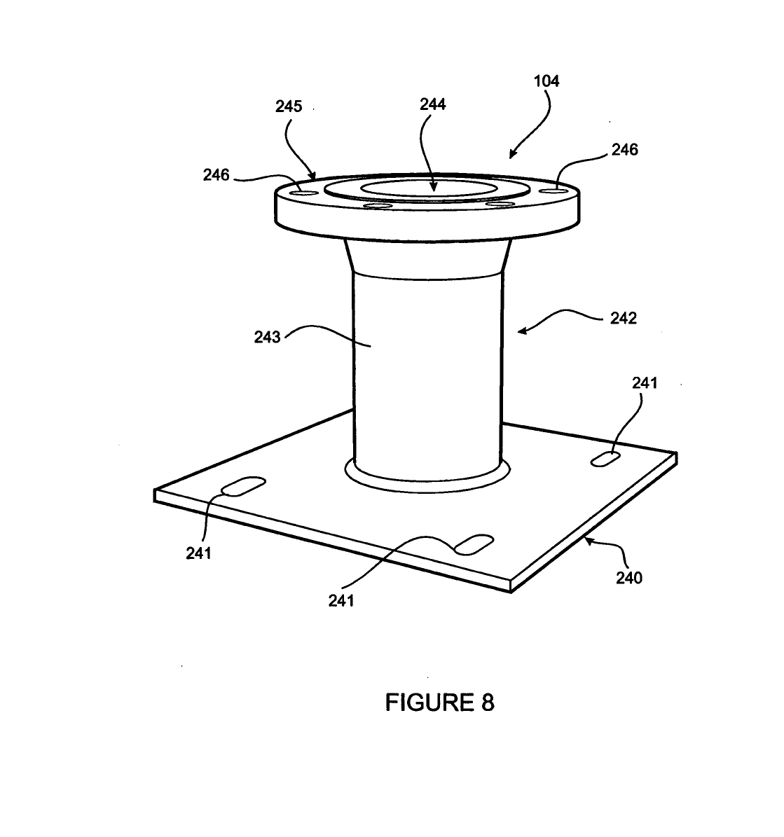

Referring to FIG. 8, the mockup outlet 104 includes a base plate 240 that has a plurality of openings 241. In addition, the outlet 104 includes a pipe 242. Pipe 242 includes a wall 243 that defines a bore 244. A lower end of the pipe 242 is welded to the base plate 240. A flange 245 is welded to the pipe wall 243 such that the flange 245 is located adjacent to an upper end of the pipe 242. The flange 245 includes a plurality of circumferentially-spaced holes 246.

Valve body 101 is mounted on the mockup outlet 104 by: resting the valve body flange 125 on top of the outlet flange 245; aligning the holes 126 in the flange 125 with the holes 246 in the flange 245; inserting a respective bolt 247 (see FIG. 1) into each pair of aligned holes 126, 246; screwing a respective nut (not depicted) onto a threaded portion of each bolt 247; and then tightening each nut.

The mockup outlet 104 may, for example, represent a wellhead of a crude oil and/or natural gas well such as, for example, a subsea oil and/or gas well. The valve apparatus 100 may be used to control the flow of oil and/or natural gas from the well by firstly securing the valve body 101 relative to the outlet 104 in the manner just described so that the oil and/or gas is able to flow into the first end 191 of the first passage 190 of the body 101. The valve member 102 can then be moved along the first passage 190 so as to control the flow of the oil and/or gas from the first passage 190 into each second passage 193 of the body 101.

If the second end 204 of the valve member passage 202 is not sealed by the cap 103, and the valve member 102 is in an open position, at least some of the crude oil and/or natural gas that enters the first passage 190 of the valve body 101 will be diverted so that it flows from the first passage 190 into the second passages 193, and then out of the valve body 101 from the passages 193. The amount of crude oil and/or natural gas that is diverted to flow into the second passages 193 from the first passage 190 will depend on the extent to which the valve apparatus 100 has been opened.

If the valve member 102 is in a closed position while the second end 204 of the valve member passage 202 is not sealed by the cap 103, none of the oil and/or gas entering the first passage 190 of the valve body 101 will be diverted to flow into the second passages 193 from the first passage 190. Instead, all of the oil and/or gas entering the first passage 190 from the outlet 104 will continue to flow through the first passage 190, and will then flow through the valve member passage 202 before exiting the valve apparatus 100 from the second end 204 of passage 202.

If the second end 204 of the valve member passage 202 is sealed by the cap 103, and the valve member 102 is in an open position, most of the crude oil and/or natural gas that enters the first passage 190 of the valve body 101 will be diverted so that it flows from the first passage 190 and into the second passages 193, and then out of the valve body 101 through the passages 193. Any crude oil and/or gas that does not flow from the first passage 190 into the second passages 193 will be prevented from flowing out of the valve member passage 204 by the cap 103. The amount of crude oil and/or natural gas that enters the second passages 193 from the first passage 190 will depend on the extent to which the valve apparatus 100 has been opened.

If the valve member 102 is in a closed position while the second end 204 of the valve member passage 202 is sealed by the cap 103, none of the oil and/or gas entering the first passage 190 of the valve body 101 will flow out of the valve apparatus 100 so that the flow of oil and/or gas from the outlet 104 is effectively shut-off by the apparatus 100.

The second passages 193 may be connected to a storage device such as a tank or tanker by hoses or pipes so that oil and/or gas that flows out of the passages 193 will be transferred to the tank or tanker by the hoses or pipes for storage.

The flow of fluid such as oil and/or gas from the second passages 193 can be further controlled by valves that are connected to those passages 193. For example, valves such as the ball valve 250 illustrated in FIG. 9 may be secured to each of the flanges 180 of the valve body 101 so that the valves 250 are able to be used to control the flow of oil and/or gas out of the valve body 101 through the passages 193.

Ball valve 250 includes a valve body 251 that includes a pair of flanges 252 located at opposite ends of the valve body 251. Each flange 252 includes a plurality of circumferentially-spaced holes 253. In addition, valve 250 includes a lever 254 for controlling the operation of a valve member or disc (not depicted) that is located inside the valve body 251. The valve member or disc is able to be moved between an open position and a closed position by suitably pivoting the lever 254 relative to the valve body 251. When the valve member is moved to an open position, fluid is permitted to flow through the valve body 251 from one end of the valve body 251 to the other end of the valve body 251 from which it will flow out of the valve body 251. When the valve member is moved to the closed position, fluid is not permitted to flow through the valve body 251.

The ball valve 250 may be secured to the valve body 101 by: resting one of the ball valve flanges 252 on one of the flanges 180, aligning each of the holes 253 in that flange 252 with a respective hole 181 of the flange 180 on which the flange 252 rests; inserting a respective bolt into each of the aligned holes 181, 253; screwing a respective nut onto a threaded portion of each bolt; and then tightening each of the nuts.

The valve apparatus 100 can be used to test whether there has been any damage to an oil and/or gas well as a result, for example, of the well experiencing a sudden spike in pressure after being suddenly shut down by the apparatus 100. The apparatus 100 is capable of allowing this to be done without any oil and/or gas being spilled from, or flowing uncontrollably from, the well outlet 104. To do this, the valve apparatus 100 is closed so that no oil and/or gas is able to flow out of the apparatus 100. If it is determined that the well or geological formation in which the well resides has been damaged in some way so that oil and/or gas is bypassing the apparatus 100 and escaping from the well, the apparatus 100 may then be opened to allow oil and/or gas to be diverted from the first passage 190 to the second passages 193 so that it flows out of the apparatus 100 from the second passages 193. The oil and/or gas that flows out of the passages 193 is transferred to a tank or tanker by pipes and/or hoses that are connected to the valve body 101. In this way, further damage to the well and/or the geological formation may be prevented while at the same time preventing environmental damage as a result of crude oil and/or natural gas flowing into the environment outside of the well.

The valve apparatus 100 may also be used as a standalone blowout preventer, or it may form only part of a blowout preventer (e.g. be part of a blowout preventer stack). In the case where the apparatus 100 is used as a standalone blowout preventer, the valve member 102 would be moved to the open position during normal operation of the well, and valves, such as a plurality of the ball valves 250 that are secured to the valve body 101 in the manner previously described, may be in the open position so that oil and/or natural gas from the well is able to flow out of the apparatus 100 via the passages 193 for collection and storage. If a potential blowout situation is detected, the hydraulic rams/cylinders of the apparatus 100 will automatically operate to move the valve member 102 to the closed position to prevent oil and/or gas from the well from flowing out of the valve apparatus 100 via the passages 193. The apparatus 100 would be operated in a similar manner if it was part of a blowout preventer rather than being a standalone blowout preventer.

Even if the valve apparatus 100 is not mounted on the well outlet 104 either directly or indirectly via other equipment such as another blowout preventer, the apparatus may still be used to get the well back under control after a blowout. If necessary, any damaged equipment such as a failed blowout preventer would firstly be removed from the well outlet 104 so that the valve body 101 could be secured to the outlet 104. The valve member 102 would be in the open position so that oil and/or gas that flows from the outlet 104 would flow out of the apparatus 100 through the passages 193 so that it could be collected and stored. Then, the valve member 102 would be moved to the closed position to prevent any further oil and/or gas from flowing out of the apparatus 100, i.e. the well would be shutdown. If, after shutting the well down it is determined that the well and or geological formation in which the well resides has been damaged and that oil and/or gas is leaking under pressure from the well, the pressure in the well could be relieved simply by moving the valve member 102 to the open position so that oil and/or gas could once again flow from the outlet 104, through the apparatus 100, out of the passages 193, and to a storage facility without polluting the environment. This pressure relief could be continued until the well is repaired.

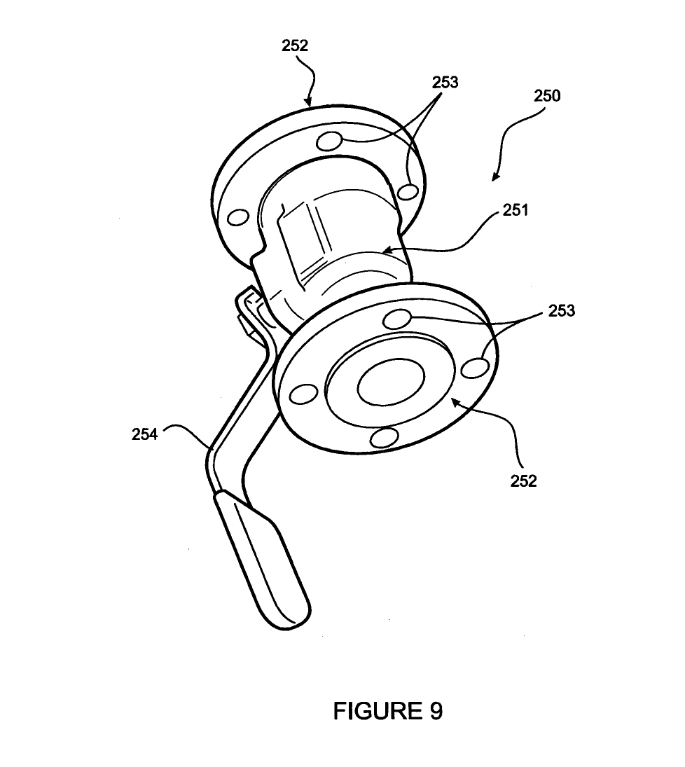

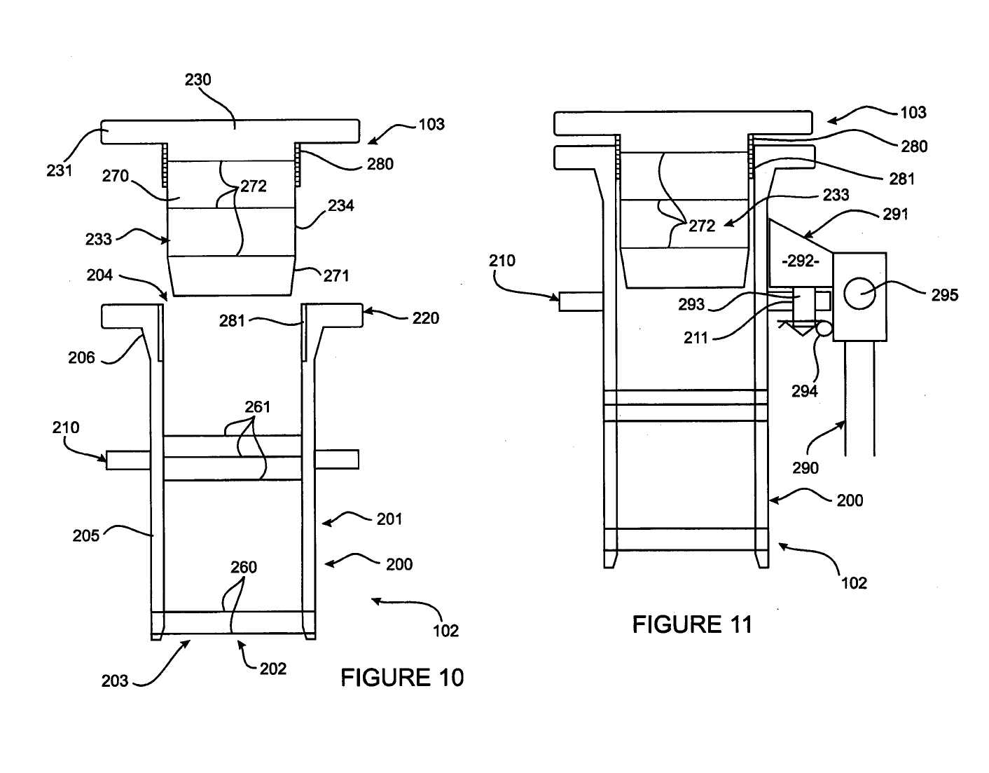

An alternative valve member 102 and an alternative valve member cap 103 for the valve apparatus 100 are illustrated in FIG. 10. The alternative valve member 102 is similar to the previously described valve member 102, and includes a plurality of O-ring seals 260 that are each mounted in a respective groove (not depicted) that extends around the external circumference of the cylindrical pipe wall section 205 of the valve member 260. A first one of the O-ring seals 260 is spaced from the lower end of the pipe wall section 205 by a distance of 20 mm, and a second one of the O-ring seals 260 is spaced from the first one of the O-ring seals 260 by 50 mm. The O-ring seals 260 are able to form a seal between the valve body 101 and the valve member 102.

In addition, the alternative valve member 102 includes a plurality of 3 mm O-ring seals 261 that are each mounted in a respective groove (not depicted) that extends around the internal circumference of the cylindrical pipe wall section 205. At least some of the O-ring seals 261 are located a similar distance along the length of the pipe wall section 205 as the flange 210.

The cylindrical pipe wall section 205 of the alternative valve member 102 is made from hydraulic steel tubing, and has an external/outside diameter of 147 mm, an internal diameter of 125 mm, and a wall thickness of 22 mm. In other preferred embodiments, the cylindrical pipe wall section 205 may be 35 mm, 220 mm, 335 mm, or 360 mm pipe. In one particular preferred embodiment, the pipe wall section 205 is 120 mm pipe that has a wall thickness of 11.7 mm.

The alternative cap 103 depicted in FIG. 10 is similar to the previously described cap 103. A pipe 233 of the alternative cap 103 includes a wall 234 that has a cylindrical section 270 and a tapered conical section 271. The cylindrical section 270 is made from hydraulic steel, and has an external diameter of 124 mm. A plurality of 3 mm O-ring seals 272 are each mounted in a respective groove (not depicted) that extends around the external circumference of the cylindrical section 270. O-ring seals 272 are for forming a seal between the cylindrical section 270 and the pipe wall 201 of the valve member 102 when the pipe 233 of the cap 103 is inserted into the bore 202 of the valve member pipe 200. A first one of the O-ring seals 272 is spaced from a lower end of the pipe 233 by 40 mm. A second one of the O-ring seals 272 is spaced from the lower end of the pipe 233 by 70 mm. A third one of the O-ring seals 272 is spaced from the lower end of the pipe 233 by 90 mm. There are no O-ring seals mounted on the tapered conical section 271 of the pipe wall 234.

The valve member 102 and the cap 103 that are illustrated in FIG. 10 may be constructed from any suitably sized pipes and flanges. The pipes and flanges are preferably from class 150-2000 plus. They may also be made from suitable grades of stainless steel. In addition, the pipes and flanges can be made tested to order to suit user needs and requirements.

The uppermost O-ring seal 272 of the cap 103 as well as the groove in which that O-ring seal is mounted may be replaced with an external thread 280 on the cylindrical pipe section 270, and the valve member pipe 200 may have an internal thread 281 so that the cap 103 can be secured to the valve member 102 by threadably engaging the external thread 280 with the internal thread 281 and then screwing the cap 103 on to the valve member 102. FIG. 11 depicts this version of the valve member 102 and the cap 103 after the cap pipe 233 has been screwed into the valve member pipe 200. The valve member bore 202 is able to be sealed by the cap 103 by screwing the cap pipe 233 into the valve member pipe 200. The cap pipe 233 extends into the valve member bore 202 by 190 mm after the cap pipe 233 has been screwed as far as possible into the valve member bore 202.

FIG. 11 also depicts a piston rod 290 that is secured to the flange 210 of the valve member 102. Piston rod 290 is part of a hydraulic cylinder that is operable to move the valve member 102 back and forth along the first passage 190 of the valve body 101 so as to control the flow of fluid from the first passage 190 into the second passages 193 of the valve body 101.

The piston rod 290 is secured relative to a support 291 that includes a body 292 that rests on top of the flange 210, and a pin 293 that extends downwardly from the body 292 and through one of the flange holes 211. A lateral passage (not depicted) extends through the pin 293 such that the passage is located on an opposite side of the flange 210 to the body 292. An R-clip 294 is inserted through the lateral passage in the pin 293 such that the clip 294 is able to prevent the pin 293 from being unintentionally withdrawn from the flange hole 211. A pin 295 extends through the support 291 and the piston rod 290 such that the piston rod 290 is thereby secured to the support member 291.

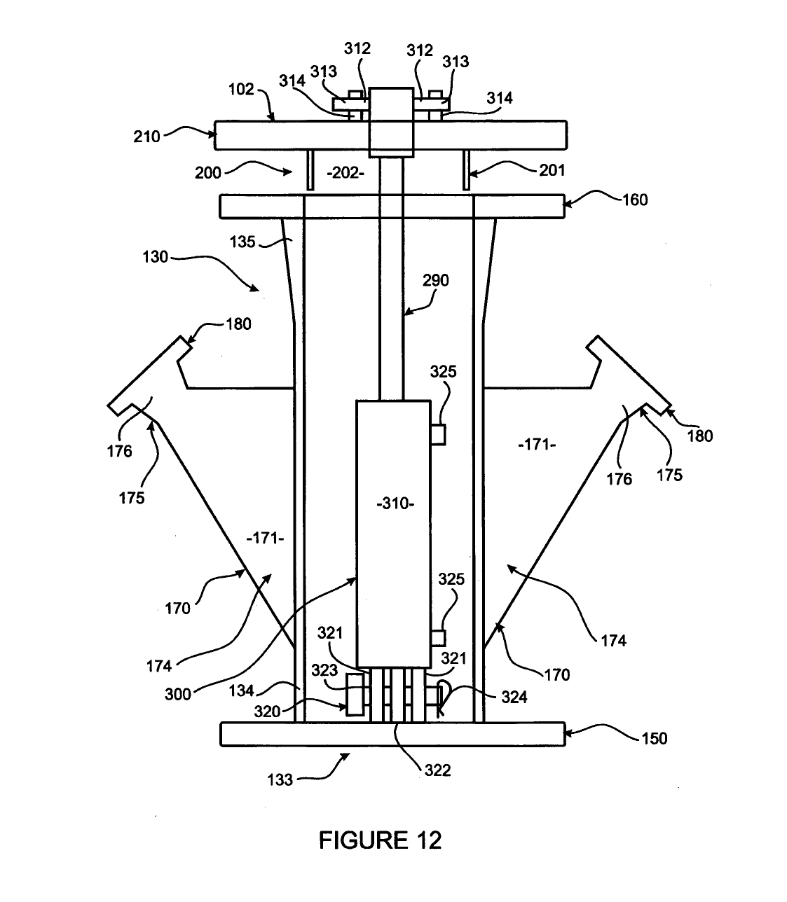

Referring to FIG. 12 which depicts an alternative second part 130 of the valve body 101, an alternative valve member 102 received in the pipe bore 133 of the second part 130 such that the valve member 102 can be moved back and forth along the bore 133, and three hydraulic rams/cylinders 300 that are operable to move the valve member 102 back and forth along the bore 133.

The second part 130 depicted in FIG. 12 is virtually identical to the previously described second part 130. The first-mentioned second part 130 also has chambers 174. The chambers 174 are able to function as anti-spike gas expansion chambers. Also, the bore 133 of the second part 102 is able to function as an absorption chamber.

Each hydraulic cylinder 300 has a load capacity of 4 tons, and the hydraulic cylinders 300 are positioned such that each cylinder 300 is located between a respective pair of the three housings 170 of the second part 130. Each cylinder 300 includes a barrel 310 that includes a bore (not depicted). A piston (not depicted) is received within the barrel bore such that the piston is able to move back and forth along the bore. A piston rod 290 is secured to the piston so that the movement of the piston is able to extend and retract the rod 290 relative to the barrel 310. A distal end of the piston rod 290 is secured to the flange 210 of the valve member 102 by a pair of rods/pins 312 that extend from the rod 290, and that are each received by a respective hole 313 in a respective flange 314 that is secured to the flange 210. A distal end of the barrel 310 is secured to the flange 150 of the second valve body part 130 by a pin 320 that extends through holes (not depicted) in a pair of flanges 321 that extend from barrel 310, and through a hole (not depicted) in a flange 322 that is secured to the flange 150 and that extends between the two flanges 321. Pin 320 includes an enlarged head 323 at one end, and a laterally extending passage (not depicted) at its other end. An R-clip 324 is inserted through the laterally extending passage to prevent the pin 320 from being withdrawn from the holes in the flanges 321, 322.

The cylinders 300 may have their own power pack (not depicted) to operate the cylinders 300. The power pack would be connected to ports 325 of the barrel 310.

Once the cylinders 300 have been operated to move the valve member 102 so as to prevent the flow of fluid from the first passage 190 and into the second passages 193 (i.e. the valve apparatus 100 is closed), the flanges 160, 210 can be bolted or otherwise secured together.

The hydraulic cylinders 300 can be operated to open and close the valve apparatus 100 as desired. If the apparatus 100 is mounted on an outlet of a subsea oil and/or gas well, and if problems with leakage of oil and/or gas appear in the sea/ocean bed and/or around the well shaft when the valve apparatus 100 is closed, the pressure in the well can be relieved simply by operating the hydraulic cylinders 300 to open the valve apparatus 100 so that oil and/or gas from the well is able to flow out of the apparatus 100 through the second passages 193 and be stored in a controlled manner. As the oil and/or gas flows out of the apparatus 100 through the second passages 193, a region of low pressure will be created within the first passage 190 if the valve member bore 202 has not been sealed, and this will cause sea water to be “sucked” into the bore 202 and will prevent or at least inhibit oil and/or natural gas from flowing out of the apparatus 100 through the bore 202.

In this way, the apparatus 100 is able to keep the environment, including the sea/ocean, safe from uncontrolled leaks of oil and/or gas from the subsea well, whilst at the same time allowing the oil and/or gas to be recovered from the well.

The valve apparatus 100 that includes the second body part 130, valve member 102, and hydraulic cylinders 300 depicted in FIG. 12 is a schedule 150 ISA small unit. However, if necessary, it can be built with pipe and flanges up to and beyond 1500.

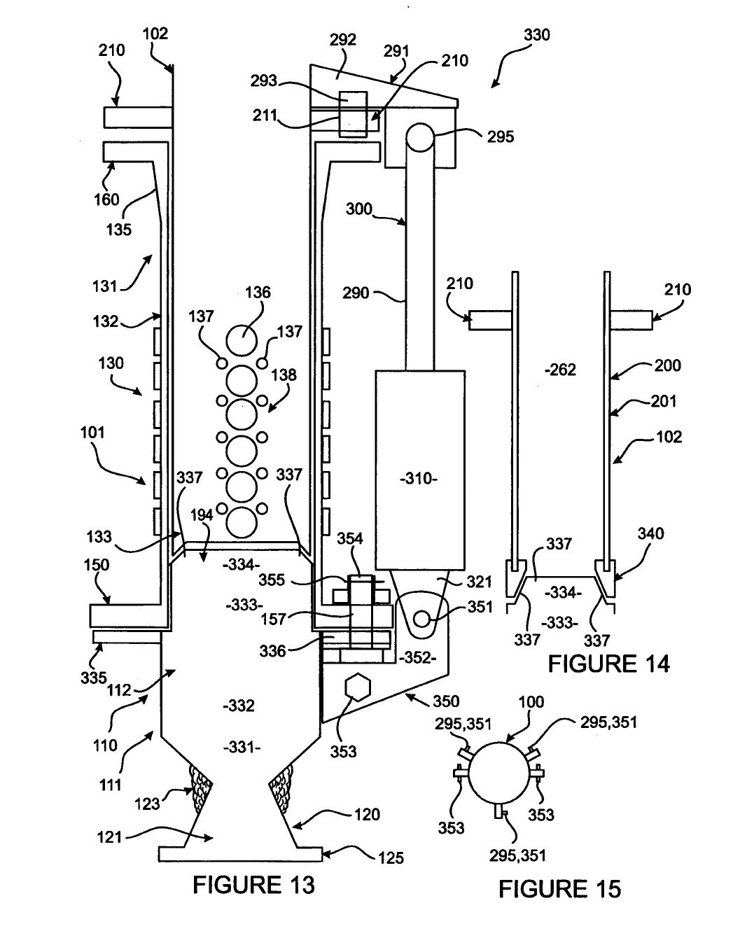

FIG. 13 depicts a valve apparatus 330 that is similar to the apparatus 100. The first part 110 of the valve body 101 of the valve apparatus 330 has a pipe 111 secured to the tapered pipe 120 by a weld 123. Pipe 111 includes a wall 112 that defines a bore of the pipe 111. Wall 112 includes a first truncated conical section 331, a first cylindrical section 332, a second cylindrical section 333, and a second truncated conical section 334. The diameter of the second cylindrical section 333 and the diameter of the second truncated conical section 334 are slightly less than the diameter of the bore 133 of the second part 130 so that the sections 333 and 334 can both be inserted into the lower end of the bore 133. Also, the diameter of the first cylindrical section 332 is greater than the diameter of the bore 133 so that the first cylindrical section 332 cannot be inserted into the bore 133. The first part 110 also has a flange 335 that is secured to the first cylindrical section 332 of the pipe wall 112. The flange 335 includes a plurality of circumferentially-spaced holes 336. The second truncated conical section 334 has an external surface 337 that functions as a valve seat 194 of the valve apparatus 330. The flanges 150, 335 are bolted together so that the first part 110 and the second part 130 of the valve body 101 are thereby secured to each other.

A rubber seal 340 that is in the form of a cup is secured to a lower end of the valve member 102, and is sealingly engagable with the valve seat 194. In particular, the seal 340 is secured to the lower end of the valve member pipe 200 as shown in FIG. 14. The seal 340, when pressed against the valve seat 194 by the operation of the hydraulic cylinders 300, results in a seal being formed between the valve member 102 and the valve seat 194 which prevents fluid from flowing from the first passage 190 and into the second passages 193.

Each hydraulic cylinder 300 is secured relative to the valve member 102 in a manner which is similar to that described previously with reference to FIG. 11. However, the flanges 321 of each hydraulic cylinder 300 are each secured to a respective support 350 by a locking pin 351 that extends through the holes in the flanges 321 as well as a hole in the support 350. Each support 350 includes a body 352 that is held together by a plurality of hexagonal bolts 353. A pin 354 that is secured relative to the support body 352 extends through aligned holes 151, 336 in the flanges 150, 335. The pin 354 includes a laterally extending passage through which another pin 355 is inserted so as to prevent the pin 354 from being withdrawn from the holes 151, 336. With reference to FIG. 15, the pins 295 and 351 that secure the hydraulic cylinders 300 to the supports 291, 350 are able to be removed.

After the hydraulic cylinders 300 of the valve apparatus 330 illustrated in FIG. 13 are operated to close the apparatus 330 to prevent fluid from flowing from the first passage 190 and into the second passages 193, the flanges 160 and 210 may be bolted together.

The valve apparatus 330 that is depicted in FIG. 13 and that includes the hydraulic cylinders 300 is suitable for use in an underwater environment. For example, it may be suitable for use in a subsea environment.

The valve body 101 of the valve apparatus 330 illustrated in FIG. 13 has a length of 680 mm. The valve member 102 is 540 mm long. The cap 103 (not depicted) of the apparatus 330 is 200 mm long. When the valve apparatus 330 is closed, the apparatus 330 has an overall length of 880 mm. When the apparatus 330 is fully open, it has an overall length of 1490 mm. Other versions of the valve apparatus 330 can be made so that they are even longer. For example, they can be made so that they have an overall length of between 2 to 5 m when they are fully open. The size of the apparatus 330 that would need to be used in a given situation would depend on a number of factors, including the amount or volume of oil and/or the flow rate of oil that the apparatus 330 needs to be able to handle.

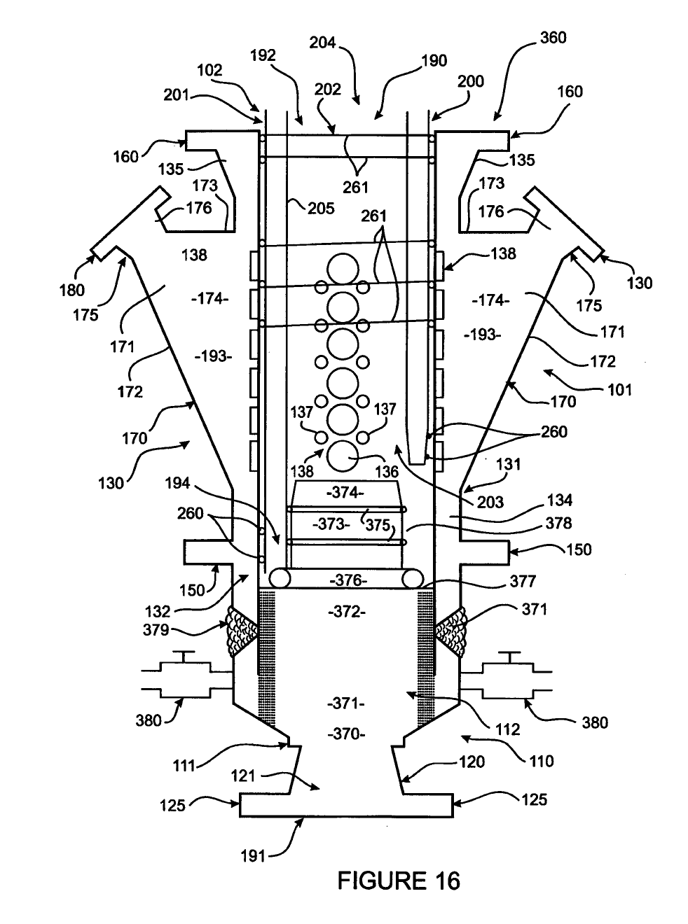

A valve apparatus 360 that is also similar to the valve apparatus 100 is depicted in FIG. 16. Apparatus 360 includes a valve body first part 110 that has a pipe 111 secured to a tapered pipe 120. Pipe 111 includes a wall 112 that defines a bore of the pipe 111. Wall 112 includes a first cylindrical section 370, a first conical section 371, a second cylindrical section 372, a third cylindrical section 373, and a second conical section 374.

The diameter of the second conical section 374 and the diameter of the third cylindrical section 373 are both less than the diameter of the bore 202 of the valve member 102 so that both the section 374 and the section 373 are able to be inserted into the bore 202. A plurality of grooves (not depicted) extends around the circumference of the section 373, and a respective rubber O-ring seal 375 is mounted in each groove. A valve seat 194 of the valve body 101 which includes an end surface of the section 372 as well as a surface 378 of the section 373 also includes a 10 mm crush rubber O-ring seal 376 that rests against the end surface 377. When the valve member 102 is lowered within the valve body 101 so that the lower end of the valve member 102 presses down against the O-ring seal 376, a seal is created between the bottom of the valve member 102 and the valve seat 194. Back pressure of fluid within the first passage 190 maintains the O-ring seal 376 in place.

Sections 372, 373, and 374 are inserted into the bore 202 of the valve body second part 130, and a weld 379 secures the first part 110 to the second part 130.

A plurality of fine shutdown taps or valves 380 are connected to the valve body 101 such that the valves 380 or in fluid communication with the first passage 190 of the valve body 101. When the valves 380 are open, fluid is able to flow from the first passage 190 and through the valves 380. When the valves 380 are closed, fluid from the first passage 190 is unable to flow through the valves 380.

Although the valve apparatus 360 has three second passages 193, it is not necessarily limited to having this number of second passages 193. The valve apparatus 360 or any of the other valve apparatus disclosed herein could have any desired number of second passages 193. For example, the valve apparatus 360 could have four, six, or eight second passages 193 depending upon, amongst other things, the size of the apparatus 360.

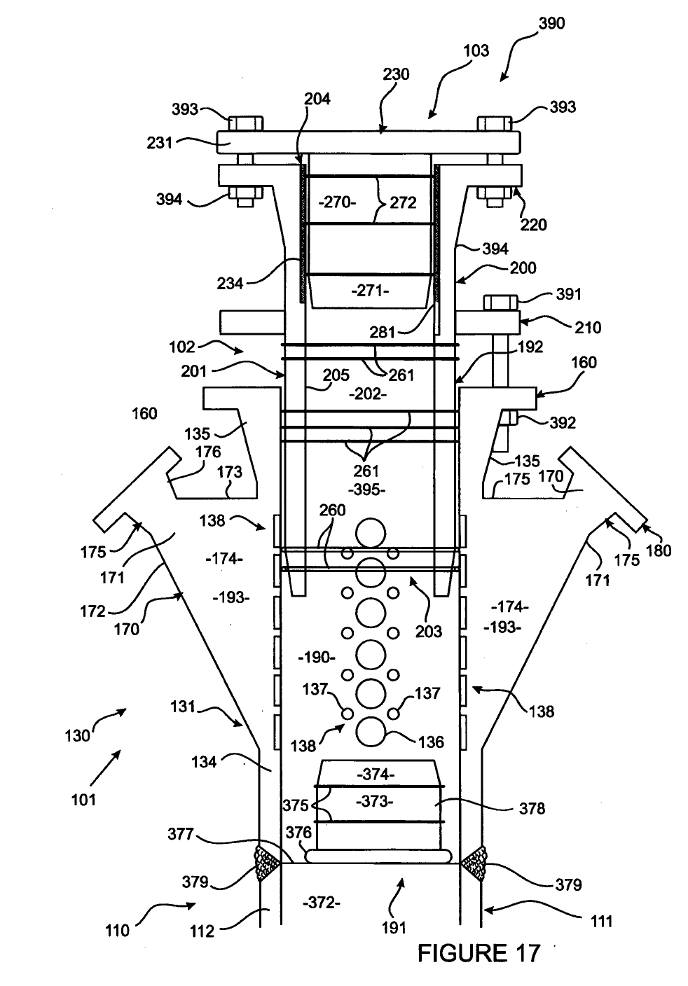

A valve apparatus 390 depicted in FIG. 17 is similar to the valve apparatus 360. However the valve body first part 110 of the apparatus 390 is welded to the second part 130 at a location which is adjacent to the end surface 377.

Also, the valve body 101 of the valve apparatus 390 does not include a flange 150.

A bolt 391 and a nut 392 are shown securing the flange 160 of the valve body 101 to the flange 210 of the valve member 102.

The flange 231 of the cap 103 is secured to the flange 220 of the valve member 102 by a plurality of bolts 393 and nuts 394.

The upper one of the rubber O-ring seals 375 of the valve apparatus 390 is spaced from the upper end of the conical pipe wall section 374 by 20 mm. The other O-ring seal 375 is spaced apart from the upper end of the section 374 by 40 mm.

A safety balance chamber 395 that includes the first passage 190 is defined within the valve apparatus 390.

The side walls 171, front wall 172, and end wall 173 of the hollow housings 170 are preferably made from steel plate that is 10 to 15 mm thick.

The flanges 180 can be of any suitable type. Also any valves that are mounted on the flanges 180 may be of any suitable type. The flanges 180 and valves will normally be selected so as to suit the user's requirements.

In general, the flange size and pipe that is used in the construction of the valve apparatus 390 can, for example, range from 150 to over 1500 lbs.

The design of the valve apparatus 390 can be lengthened or stretched as required so that there is sufficient room to fit bolts, valves, or suction fittings to the apparatus 390.

As previously mentioned in connection with FIGS. 10 and 11, the cap/kill bung 103 can include a male screw thread 280 so that the cap 103 can be secured to the valve member 102 by screwing the pipe 233 into the valve member 102 such that the thread 280 engages with the female thread 281 of the valve member 102.

If, for example, the valve apparatus 390 is installed in a subsea environment, when suction (i.e. a lower pressure) is applied to the chambers 174 within the second passages 193, seawater is able to flow into the first passage 190 through the open top of the valve member 102 as a consequence of the negative/lower pressure that is created within the first passage 190 by the flow of fluid through the second passages 193. This will allow any large gas spikes to exit out the top of the valve apparatus 390. The valve apparatus 390 can be maintained open like this without the cap 103 installed until it is considered safe to conduct a pressure shutdown test of the well on which the apparatus 390 is installed.

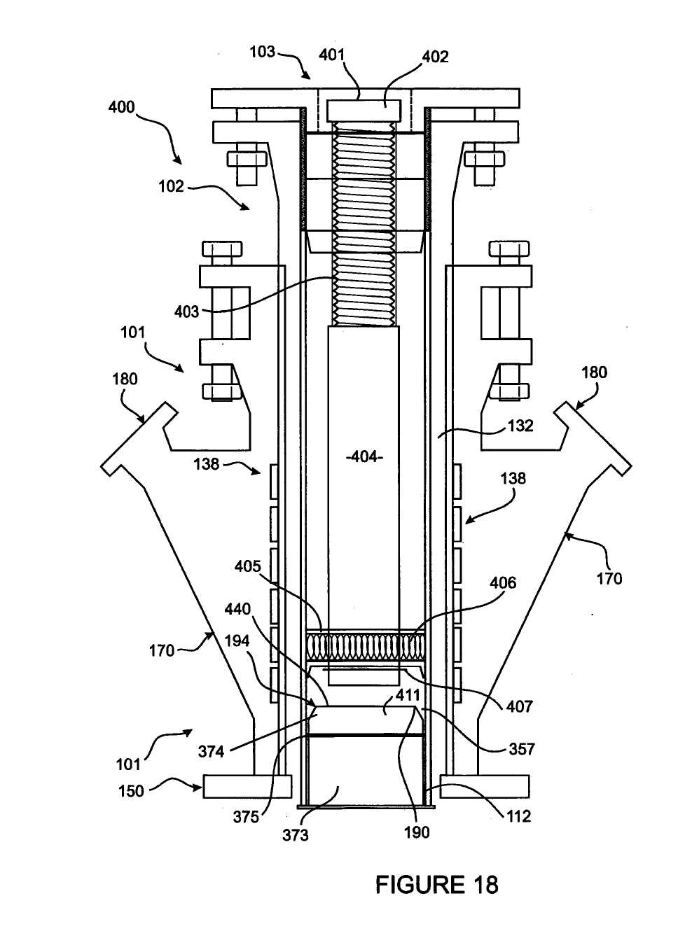

Referring to FIG. 18 a valve apparatus 400 is similar to the valve apparatus 390, except that the valve body 101 of the apparatus 400 includes the flange 150 at the lower end of the body 101.

Also, the cap 103 of the valve apparatus 400 includes a cavity 401 that contains a T-bar, nut, or Allen bolt nut head 402 to which is screwed or otherwise attached a threaded rod 403 such that the threaded rod 403 is fixedly secured to the cap 103. The threaded rod 403 is screwed into an internally threaded end of a rod 404. A flange 405 is welded to the rod 404 such that the flange is secured to the rod 404 and is located adjacent to an opposite end of the rod 404 to the threaded shank 403. A hollow circular rubber seal 406 is mounted on the rod 404 adjacent to the flange 405. The seal 406 is held in place on the rod 404 by a circlip 407.

An end wall 410 of the pipe wall conical section 374 includes a circular recess 411 that is able to function as a steel seat for the adjacent end of the rod 404.

If the cap 103 is not fixedly secured to the valve member 102 so that the cap 103 can be rotated relative to the valve member 102, rotation of the cap 103 will cause the rod 404 to be extended or retracted relative to the threaded shank 403 depending upon the direction in which the cap 103 is rotated. If the cap 103 is rotated such that the rod 404 is extended relative to the threaded shank 403, and the cap 103 is rotated in that direction by a sufficient amount, the lower end of the rod 404 will eventually press up against the bottom wall of the recess 411 to form a seal with the valve seat 194, and will cause downward pressure to be exerted on the rubber seal 406 forcing it to form a seal between it and the pipe wall 132 so that fluid is unable to flow between the first passage 190 and the second passages 193.

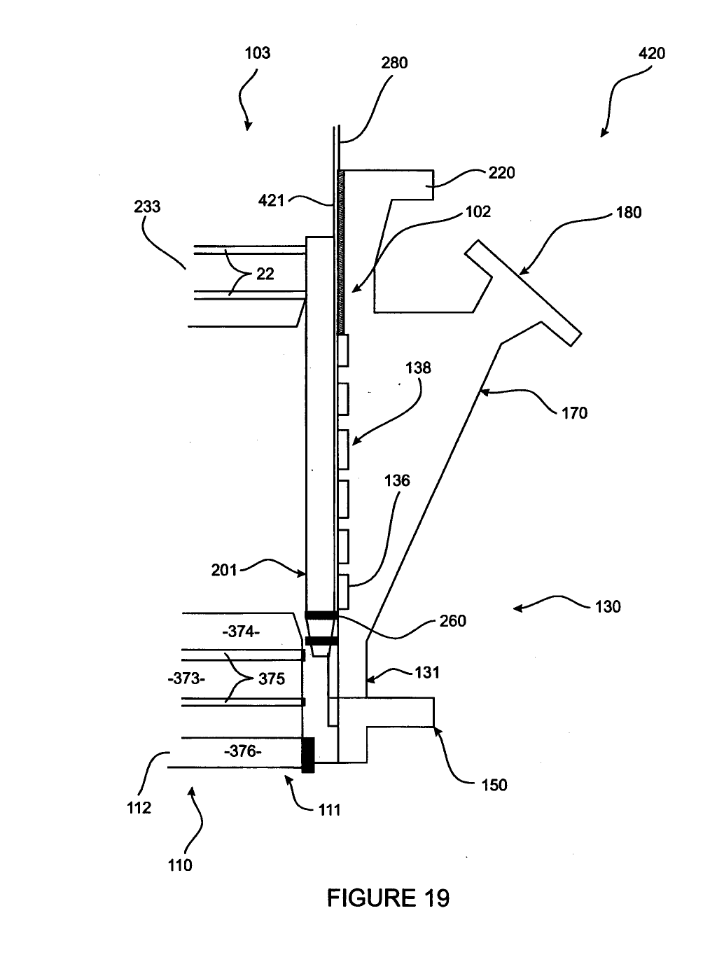

Part of a valve apparatus 420 is depicted in FIG. 19. The valve apparatus 420 is similar to the valve apparatus 360 and also the valve apparatus 390. Apparatus 420 includes the external thread 280 of those previously described valve apparatus. However, instead of including the internal thread 281 of those previously described valve apparatus the valve body 101 of the valve apparatus 420 includes an internal thread 421 so that the cap 103 of the apparatus 420 which is a valve body cap can be screwed into the valve body 101. A similar sealing arrangement may also be implemented at the bottom of the valve apparatus 420. For example, the valve body first part 110 of the apparatus 420 may include an external thread (not depicted), and the valve body second part 130 of the apparatus 420 may include an internal thread (not depicted) so that the first part 110 can be secured to the second part 130 by screwing it into the second part 130.

The valve member 102 of the valve apparatus 420 is moved downwardly within the valve body 101 to close down/stop the flow of fluid through the apparatus 420 when the cap 103 is screwed into the valve body 101.

In order to prevent fluid from flowing through the valve apparatus 420 the O-ring seals 260 need to be positioned below the lowermost holes 136, 137 in the valve body 101, and also below the O-ring seals 375. When the O-ring seals 260 are positioned in this way, the valve apparatus 420 is closed so that fluid cannot pass through the apparatus 420. The O-ring seals 260, 375 do not disturb or interfere with each other as they are moved to and from this position. When the apparatus 420 is closed, the back pressure of the fluid inside the valve apparatus 420 also does not disturb the O-ring seals 260, 375, nor does it disturb the O-ring 376.

The lower end of the pipe wall 201 has a taper on both sides for a steel to steel seal. This steel to steel seal can be achieved by removing at least the bottommost one of the O-ring seals 260, whilst at the same time leaving the O-ring seals 375 in position so that they are able to hold back dirt and grime so that the steel surfaces of the pipe wall 201 and the pipe wall 112 can seal together cleanly.

The flange 150 slips onto the pipe 131 so that it supports the pipe 131. Hydraulic rams/cylinders (not depicted) that are used to move the valve member 102 of the apparatus 420 relative to the valve body 101 of the apparatus 420 are able to clip onto the flange 150.

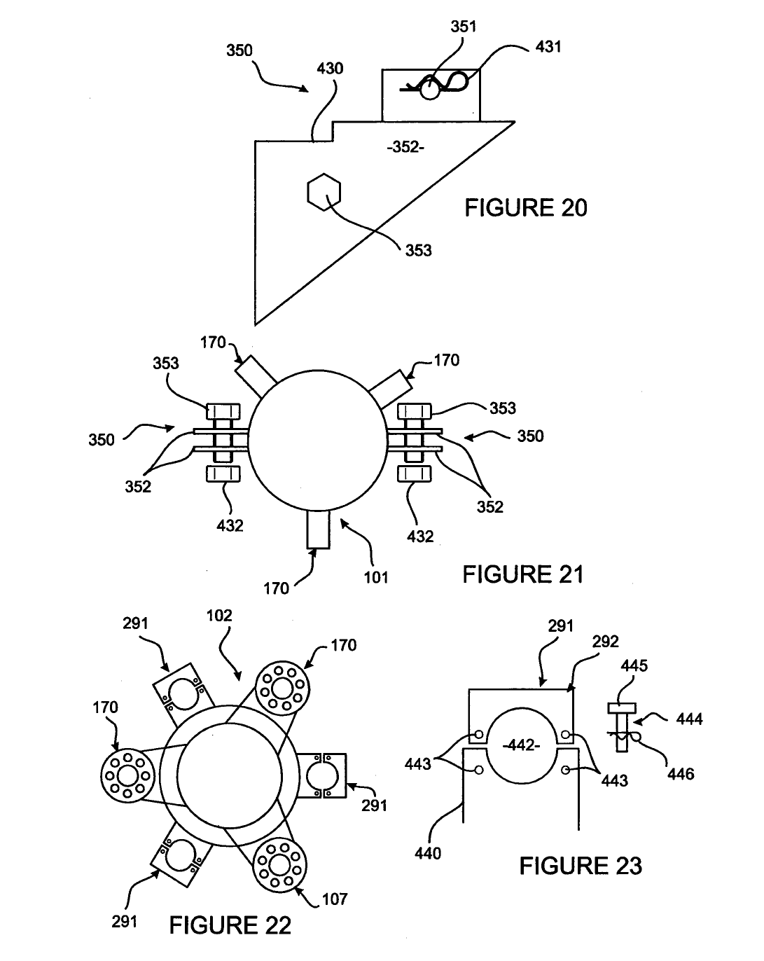

FIG. 20 depicts an alternative support 350 for securing the hydraulic rams/cylinders 300 relative to the valve body flange 150. Support 350 includes a pair of bodies 352 that are secured to each other with a hex bolt 353 and a nut. Each body 352 includes a bolt recess 430. A pin 351 is used to secure the cylinder 300 to the support 350. An R-clip 431 is used to hold the pin 351 in place.

FIG. 21 depicts a pair of the supports 350 secured relative to a valve body 101. Visible in FIG. 21 are hex nuts 432 that are used to secure the bodies 352 relative to each other.

FIGS. 22 and 23 depict an alternative support 291 for supporting the hydraulic rams/cylinders 300. Each support 291 includes a body 292 that includes a first part 440 that is secured relative to the valve member 102, and a second part 441. The first part 440 and the second part 441 fit or sleeve over each other with the upper end of the hydraulic ram/cylinder 300 positioned within an opening 442 defined by the first part 440 and the second part 441. Both the first part 440 and the second part 441 include a pair of openings/holes 443. Each hole 443 in the first part 440 aligns with a respective one of the holes 443 in the second part 441. A respective pin 444 that includes an enlarged head 445 is inserted into each pair of aligned openings 443, and a respective R-clip 446 is inserted through a transverse opening in each pin 444 to prevent the pins 444 from being removed or withdrawn from the aligned openings 443. In this way the hydraulic cylinder 300 is able to be clamped between the first part 440 and the second part 441 of the support 291.

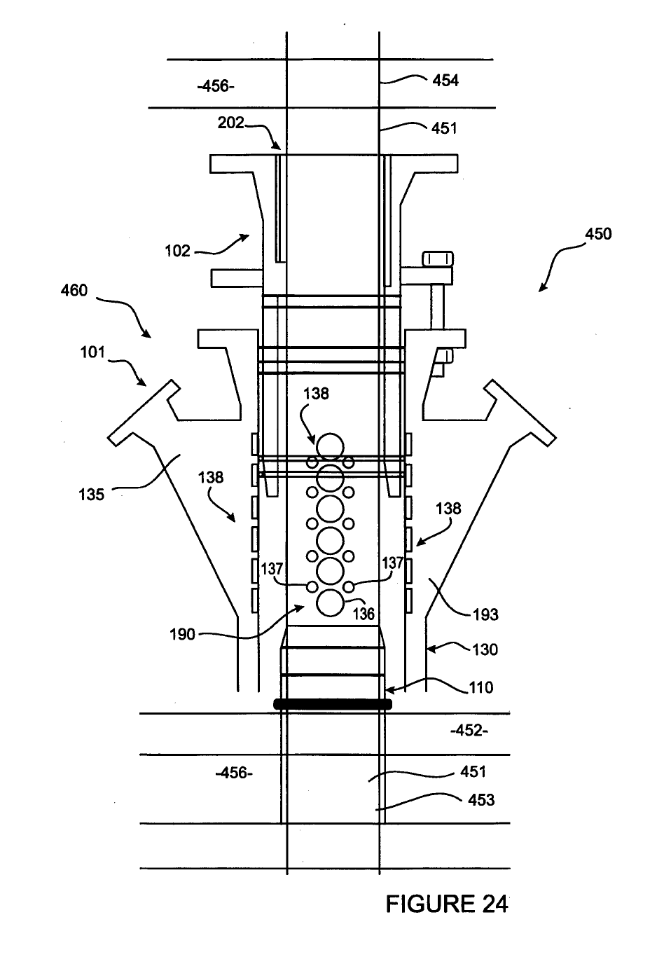

FIG. 24 depicts a valve apparatus 450 that is similar to the valve apparatus 390 except that it does not include the cap 103 of the valve apparatus 390.

A pipe 451 such as a well riser/riser string for example extends from a subsea oil and/or gas well. The pipe 451 extends through the valve body 101 and the valve member 102 of the valve apparatus 450. In particular, the pipe 451 extends through the first passage 190 of the valve body 101, and also through the bore/passage 202 of the valve member 102.

During normal operation of the well, oil and/or natural gas from the well flows up through the pipe 451 and past the valve apparatus 450.

If a blowout preventer is mounted on the pipe 451, it can be removed and replaced with the valve apparatus 450. The valve apparatus 450 can be used to shutdown the well without having to drill the bottom of the well.

If it is necessary to open the valve apparatus 450 so that oil and/or natural gas that flows through the pipe 451 is diverted to flow out of the apparatus 450 through the second passages 193 so that the oil and/or natural gas can then be captured and stored, a special pipe cutter 452 of the apparatus 450 which is located at a lower end of the valve body 101 cuts laterally through the pipe 451. The pipe 451 is consequently separated into a lower part 453 that is located below the cut, and an upper part 454 that is located above the cut.

A grab ram 455 of the valve apparatus 450 holds the lower part 453 of the pipe 451 in place so as to prevent it from falling down the well after the cutter 452 has cut through the pipe 451. The valve apparatus 450 may include a single grab ram 455, or it may have two, three or more grab rams 455.

A grab ram 456 holds the upper part 454 of the pipe 451 in place so as to prevent it from falling down the well after the cutter 452 has cut through the pipe 451. The valve apparatus 450 may include a single grab ram 456, or it may have two, three or more grab rams 456.

The valve apparatus 450 may include one or more shear rams (not depicted) that are modified to shear the pipe 451 open instead of bending it. The shear rams may for example be a four-way shear.

Hydraulic rams/cylinders (not depicted) of the valve apparatus 450 raise the valve member 102 relative to the valve body 101 after the pipe 451 has been cut by the cutters 452. The grab rams 456 continue to hold on to the pipe 451 so that the upper part 454 of the pipe 451 is raised with the valve member 102. The valve member 102 and the upper part 454 are raised sufficiently so that the openings 136, 137 are uncovered by both the valve member 102 and the upper part 454 so that oil and/or gas flowing from the well through the pipe 451 is able to flow from the first passage 190 into the second passages 193 and then out of the valve body 101 where it can then be collected and stored without polluting the environment.

The valve apparatus 450 may include a fold shear to cap the top of the pipe 451. If the top of the pipe 451 is capped, and the valve member 102 has been operated so that the valve apparatus 450 is open, oil and/or natural gas from the well is still able to flow from the first passage 190 into the second passages 193 and then out of the valve apparatus 450.

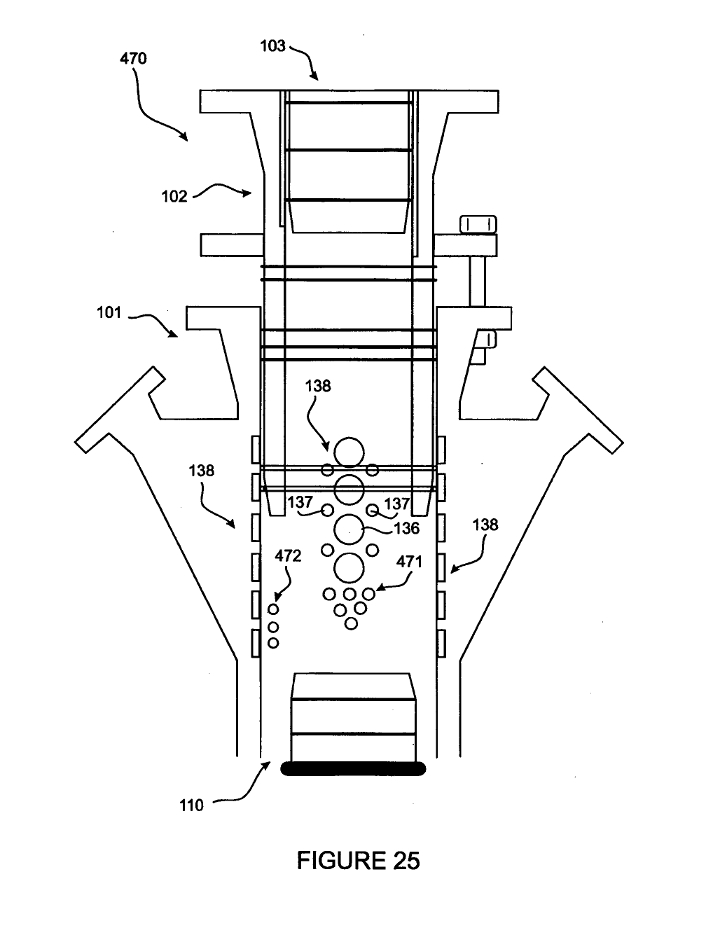

FIG. 25 depicts a valve apparatus 470 that is also similar to the valve apparatus 390, and also illustrates how each hole group 138 can be composed of different numbers, sizes, and shapes of holes. For example, each hole group 138 can include a plurality of holes in inverted triangular arrangement 471, or a linear arrangement 472. The holes in each group 138 may be in any combination, or any distance or height from the first part 110 or another group 138.

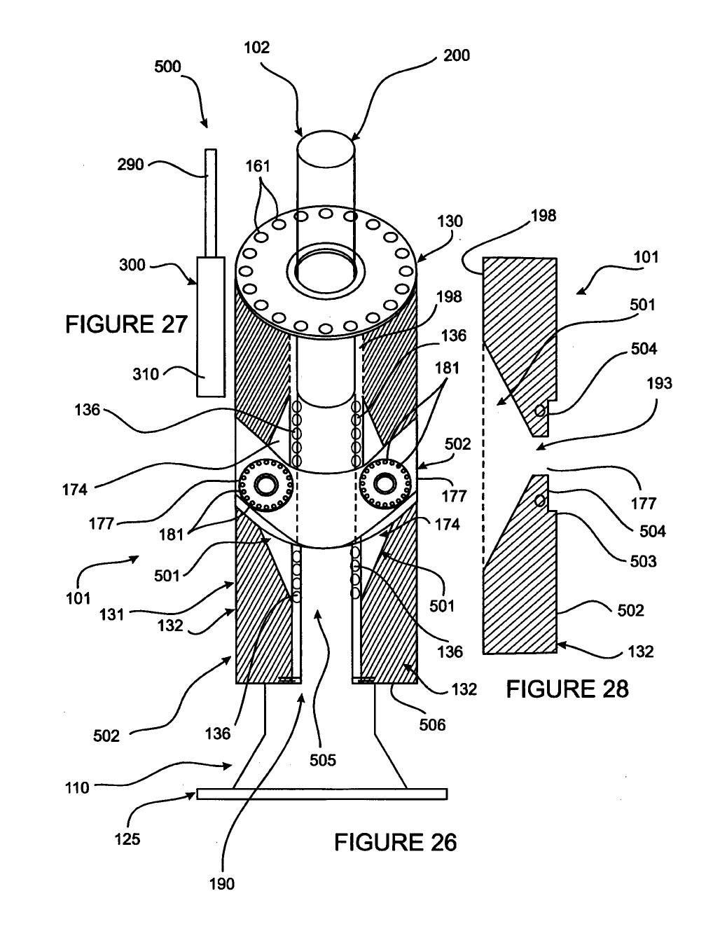

Referring to FIGS. 26 to 28, a ninth preferred embodiment of a valve apparatus 500 for controlling the flow of oil or gas from a well such as, for example, a subsea well includes a valve body 101 that includes a first part 110 and a cylindrical second part 130. A central first passage 190 extends through both the first and second parts 110, 130, and a plurality of lateral second passages 193 extends through a cylindrical wall 132 of the second part 130 laterally from the first passage 190.

Each second passage 193 includes an elongate conical or pyramidal-shaped cavity or recess 501 that extends into the wall 132 from an inner surface 198 thereof. A respective outlet hole/opening/bore 177 extends through the wall 132 from each of the recesses 501. An outer surface 502 of the wall 132 includes a plurality of recesses 503. Each recess 503 includes a machined flat lower face 504. Each bore 177 extends through the wall 132 from the lower flat face 504 of a respective one of the recesses 503. Each face 504 includes an RTJBX gasket seat. A plurality of holes 181 are positioned around the bores 177, and extend into the wall 132 from the flat faces 504. The holes 181 are drilled and tapped so that bolts (not depicted) for securing flanges, pipe, or other fittings to the valve body 101 are able to be screwed into the holes 181. A tube or tube-like wall 505 that includes one or more elongate or round inlet holes/vents/openings 136 may be located between the recesses 501 and the first passage 190 so that each recess 501 forms a chamber 174, and so that fluid is able to flow from the first passage 190 through the openings 136 into the chamber 174 and then out of the chamber 174 through the bores/openings 177. The openings 136 may be formed by suitably machining the wall 505. For example, the cavities/recesses 501 may be machined, and the openings 136 may be drilled or otherwise machined into the wall 505 prior to its insertion into the passage 190.

As with the previously described preferred embodiments, fluid such as oil and or gas is able to flow into the bottom of the valve body 101 of the valve apparatus 500 through the first passage 190.

The first part 110 of the valve body 101, including a flange 125 of the first part 110, may be made in one piece and then subsequently welded or otherwise attached to the second part 130. Alternatively, the whole valve body 101 may be formed from a single piece of machined metal.

The second part 130 of the valve body 101 may be a single piece of machined steel, a single piece of moulded/cast steel, or a combination of the two (i.e. a single piece of moulded and cast steel).

The valve member 102 of the apparatus 200 includes a centre closing tube/pipe 200 that is able to be moved up and down within the first passage 190 by suitably operating one or more hydraulic cylinders 300 of the apparatus 500. Fluid is able to flow into the second passages 193 from the first passage 190 by sufficiently extending the piston rods 290 of the cylinders 300 relative to the cylinder barrels 310 so that the valve member 102 does not block the fluid from flowing from the first passage 190 and through the openings 136. Fluid is able to be prevented from flowing from the first passage 190 and into the second passages 193 by retracting the piston rods 290 relative to the barrels 310 so that the valve member 102 covers the openings 136 and rests against a seat 506 in the second part 130.

An upper end of the second part 130 of the valve body 101 includes an RTJBX gasket seat. A plurality of holes 161 that extend into the wall 132 are positioned around the upper end of the first passage 190. The holes 161 are drilled and tapped so that bolts (not depicted) for securing flanges, pipe, or other fittings relative to the valve body 101 are able to be screwed into the holes 161.

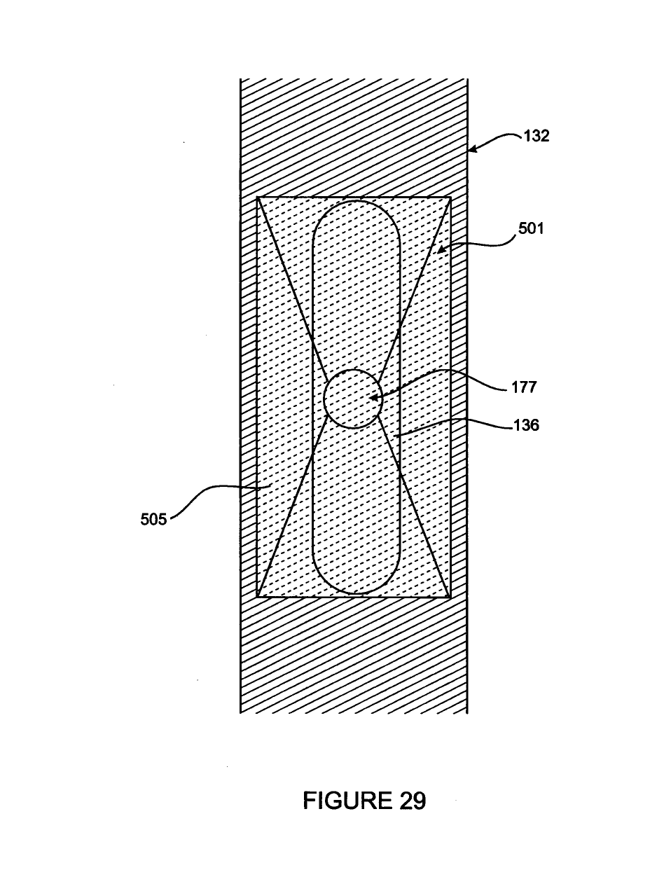

FIG. 29 depicts the inner surface 198 of the wall 132, including one of the recesses 501, bores 177, and wall 505 that includes an elongate opening 136. As mentioned previously, in some preferred embodiments, the wall 505 may not be present so that fluid is able to flow directly into the cavities or recesses 501 from the first passage 190.

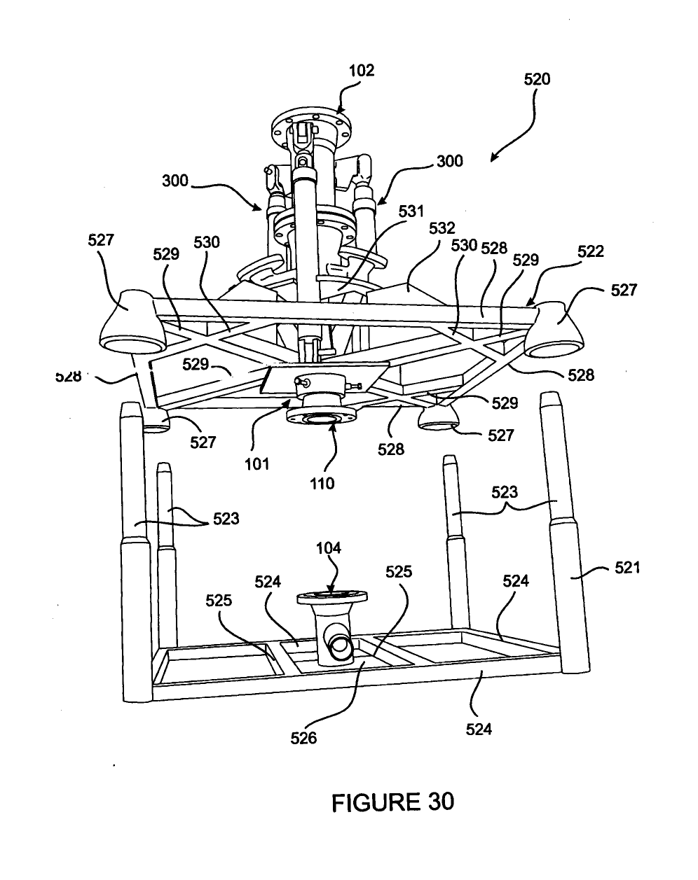

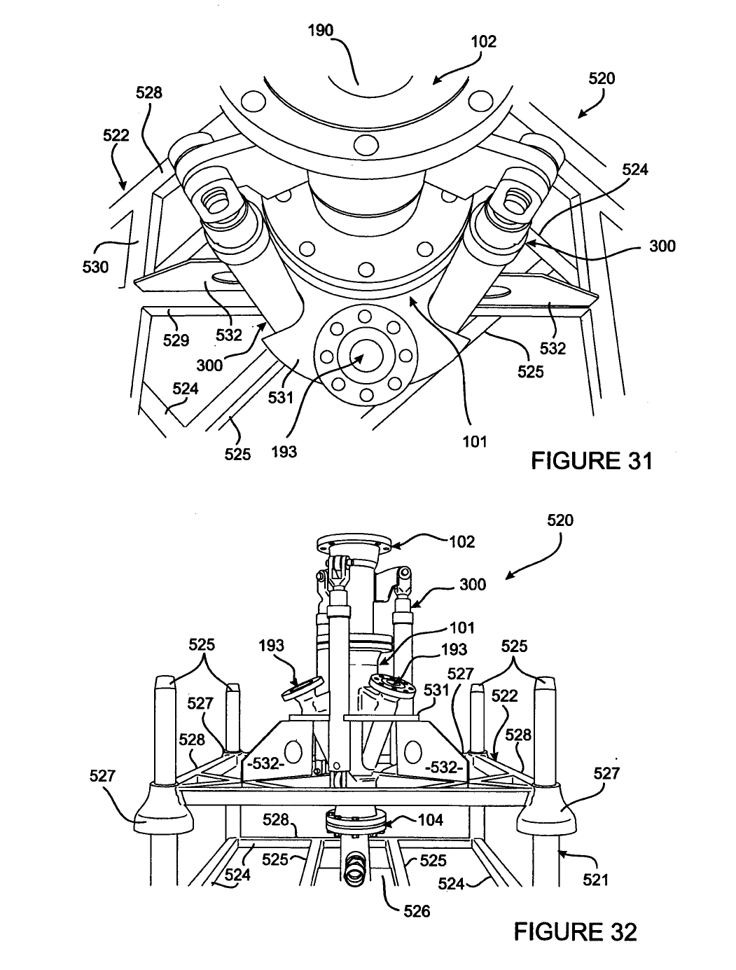

Referring to FIGS. 30 to 32, a tenth preferred embodiment of a valve apparatus 520 is similar to the valve apparatus 100. However, unlike the apparatus 100, the apparatus 520 includes a lower frame 521 secured to an outlet 104, and an upper frame 522 secured to a valve body 101 of the apparatus 520.

The lower frame 521 includes four upstanding posts 523 that are arranged such that they form the corners of a rectangle. A plurality of frame members 524 extend between and are secured to the posts 523, and a pair of frame members 525 extend between two of the frame members 524. A plate 526 is secured to the members 525 and to the outlet 104.

In use, the lower frame 521 sits or rests on a support surface. For example, if the outlet 104 is an outlet of a subsea oil or gas well, the lower frame 521 would, rest on the surface of the seabed or ocean floor which is adjacent to the outlet 104.

The upper frame 522 includes four collars 527 that are arranged such that they form the corners of a rectangle. Each collar 527 slidably receives a respective post 523. A plurality of frame members 528 extend between and are secured to the collars 527, and a plurality of diagonal frame members 529 extend from the collars 527. The diagonal frame members 529 are braced by diagonal frame members 530 that extend between the members 529 and the members 528.

The valve body 101 of the valve apparatus 520 is secured relative to the frame members 529. The valve body 101 includes a flange 531, and a plurality of support plates 532 are secured to the diagonal frame members 529 and the flange 531. A valve member 102 of the apparatus 520 is longer than the valve member 102 of the apparatus 100 to better ensure that, when fluid is able to flow from a first passage 190 of the body 101 into second passages 193 of the body 101, the amount of fluid that passes all the way through the first passage 190 is minimised or eliminated.

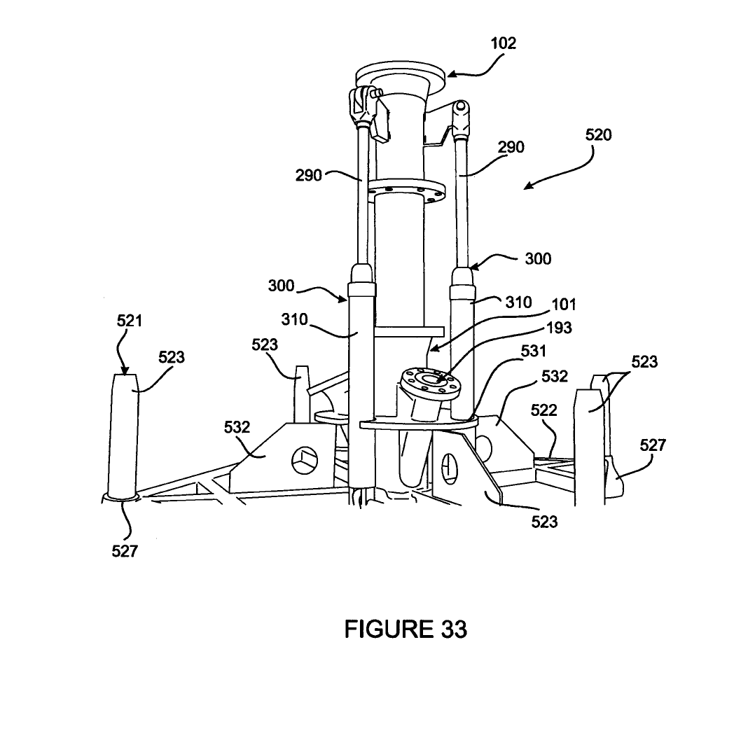

The valve apparatus 520 includes three hydraulic cylinders 300 for extending and retracting the valve member 102 relative to the valve body 101. With reference to FIG. 33, each cylinder 300 includes a cylinder barrel 310 and a piston rod 290 that is able to be extended and retracted relative to the barrel 310. When the piston rods 290 are retracted relative to the barrels 310 as shown in FIGS. 30 to 32, the valve member 102 prevents fluid from passing or flowing from the first passage 190 and into the second passages 193. When the piston rods 290 are extended relative to the barrels 310 as shown in FIG. 33, fluid is able to pass or flow from the first passage an into the second passages 193.

The lower frame 521 and the upper frame 522 of the valve apparatus 520 assist in both aligning the valve body 101 with the valve outlet 104, and mounting the valve body 101 on the valve outlet 104.

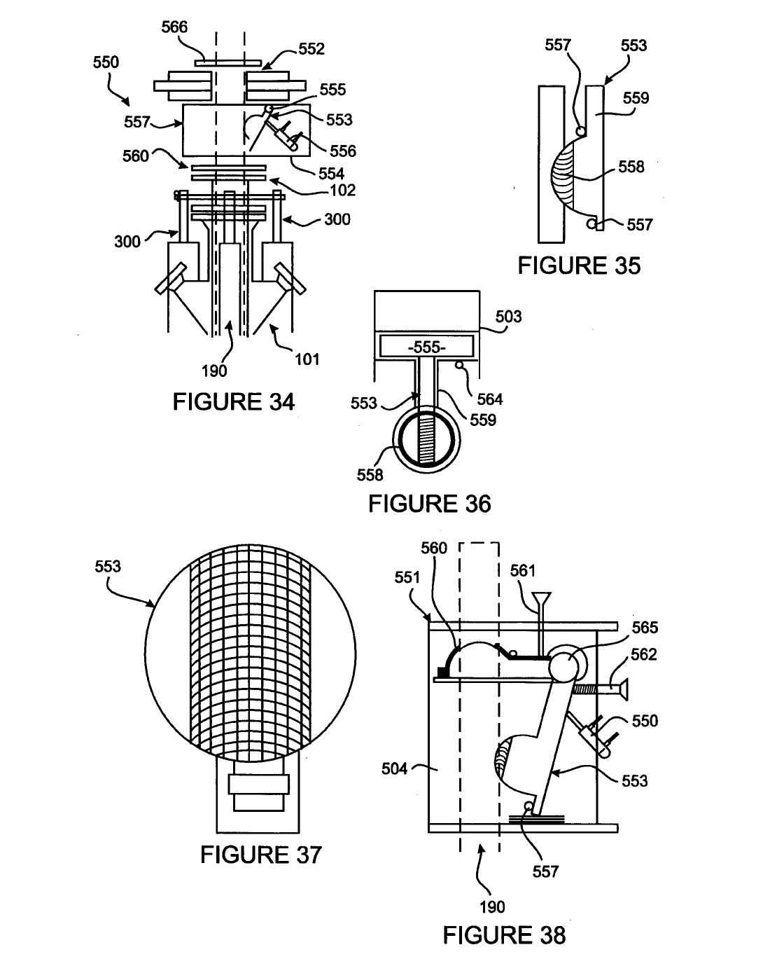

Referring to FIGS. 34 to 38, an eleventh preferred embodiment of a valve apparatus 550 is similar to the apparatus 520 in that apparatus 550 includes a valve body 101, valve member 102, and a plurality of hydraulic rams 300 for extending and retracting the valve member 102 relative to the valve body 101.

Valve apparatus 550 also includes an auto close valve 551 and manual safety override grab rams 552. The auto close valve 551 includes a pivotable valve member 553 that is housed within a housing 554 and that is able to be pivoted about a pivot 555 by extending or retracting a piston rod of a hydraulic ram/cylinder 556 relative to a barrel of the cylinder 556. Valve member 553 includes an O-ring seal 557 that extends around the base of a domed portion 558 that is located adjacent one end of an arm portion 559. When the piston rod of the cylinder 556 is retracted relative to the barrel of the cylinder 556, the valve 551 is open so that fluid is able to flow through the first passage 190 of the valve body and the third passage 202 of the valve member 102. When the piston rod is extended relative to the barrel of the cylinder 556, the valve member 553 rests against a valve seat 560 of the valve 551 so that the O-ring seal 557 forms a seal against the valve seat 560 and prevents fluid from flowing through the first passage 190 past the valve 551. Valve 551 also includes a pin or rod 561 that forms part of a hydraulic electric manual override to open or hold open the valve member 553, and a pin or rod 562 that forms part of a manual assist mechanism for opening the valve 551. The housing 554 includes a pin or pivot housing portion 563 that houses the pivot 555. The pivot 555 is slotted and is held or secured in the pivot housing portion 563 by a retainer pin 564.

The valve apparatus 550 may have a manual backup valve such as the valve 551 in case the first passage 190 is unable to be closed by other means. In many situations, it is best not to go without at least a couple of such override or final safe systems. More such systems generally allows for safer control. Alternatively, rather than using such systems, a cap such as the valve member cap 103 described previously may be secured to the top of the valve member 102 to prevent fluid from flowing out the top of the valve member 102 when the valve member 102 is retracted into the valve body 101 to prevent fluid from flowing from the first passage 190 into the second passages 193. Once the cap or pipe is removed from that passage, the fluid flow will pull or suck the valve member 553 shut and the fluid pressure will hold it closed.

A new drill string that is inserted into the top of the passage 190 will push down on the valve member 553 so that the valve 551 opens and so that fluid is able to flow through the passage 190 and the drill string.

The housing 554 is hollowed out of a bush so that the housing 554 forms around a pipe 565 that is secured to the valve member 102.

The valve 551 needs to be carefully controlled. The side vents/second passages 193 of the valve apparatus 550 need to be open before the valve 551 is closed. The grab rams 552 are also secured to the pipe 565. To seal well, a cap such as the aforementioned cap 103 is put on top of a flange 566 of the pipe 565.

All of the various flanges of the various preferred embodiments of the valve apparatus are RTJ BX flanges which are specifically designed and manufactured for well head applications.

This system can be used to extinguish blown out wells that have caught fire with no need for a manned system after being lowered by a crane or the like on to the well.

As a standby system it can be put on the blowout preventer of a well and used to bring the well under control without igniting the flame and releasing excessive amounts of deadly hydrosulphide gas into the atmosphere.

All of the components of the valve apparatus are constructed from materials that are appropriate for the task that the apparatus needs to perform. For example, in the case of the valve body 101, valve member 102, and cap 103, materials such as appropriate steels may be used in their construction. In the case of the O-rings, they are made from an appropriate sealing material, such as rubber, for example.

In the various preferred embodiments of valve apparatus that have been described, the combined size of the second passages 193 is at least as large as the size of the outlet of the well that the valve apparatus is attached or secured to.

The valve member 102 is able to be moved relative to the valve body 101 so that fluid flowing through the first passage 190 is able to be diverted to flow from the first passage 190 and through each second passage 193. For example, the valve member 102 may be able to be moved along the first passage 190 so that fluid flowing through the first passage 190 is able to be diverted to flow from the first passage 190 and into each second passage 193.

Alternatively, the valve member 102 may be able to be moved relative to the valve body 101 by rotating it relative to the valve body 101 so that fluid flowing through the first passage 190 is able to be diverted to flow from the first passage 190 and through each second passage 193. For example, there may be one or more openings in a wall of a pipe 200 of the valve member 102. The openings may be selectively aligned with the second passages 193 of the valve body 101 by rotating the valve member 102 relative to the valve body 101. When the openings in the pipe wall are aligned with the second passages 193, fluid is permitted to flow from the first passage 190 and into the second passages 193 via the pipe wall openings. When the pipe wall openings are not aligned with the second passages 193, fluid is not permitted to flow from the first passage 190 and into the second passages 193.

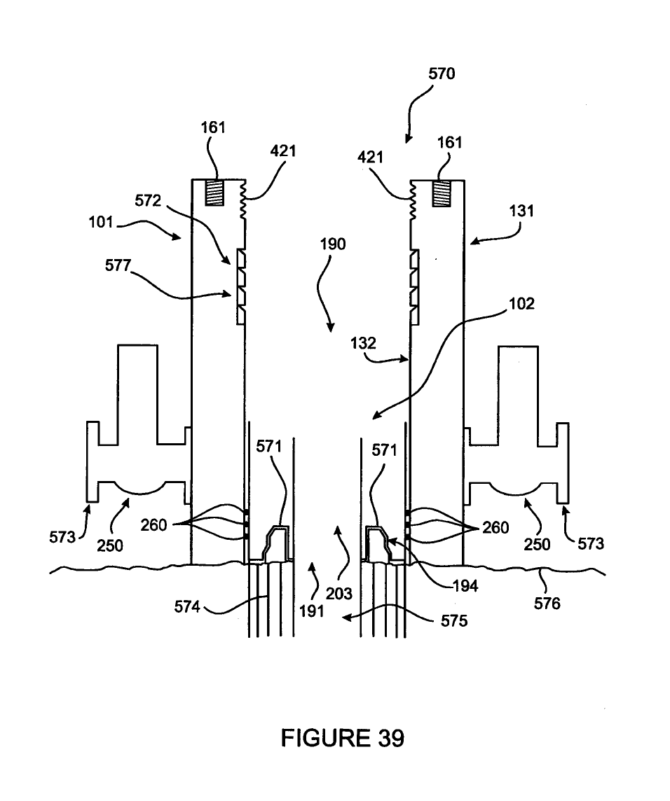

Referring to FIG. 39, there is illustrated a twelfth preferred embodiment of a valve apparatus 570.

The valve apparatus 570 includes a valve body 101 that includes a first passage 190 that extends through the valve body 101, and a plurality of second passages (not depicted) that extend through the valve body 101 and laterally from the first passage 190.

The valve body 101 includes an internal thread 421 that is located in the first passage 190 adjacent to a second end 192 thereof.

In addition, the valve body 101 includes a plurality of threaded bolt holes 161 that are located adjacent to the second end 192 so that a component can be secured to the valve body 101 adjacent to the second end 192 by a plurality of bolts that extend through the component and that are screwed into the bolt holes 161.

The valve apparatus 570 also includes a valve member 102 that includes a third passage 202 that extends through the valve member 102. The valve member 102 is able to be inserted into the first passage 190 of the valve body 101, and is able to be moved relative to the valve body 101.

The valve body 101 includes a valve seat 194 that is located adjacent to the first and 191 of the first passage 190. An end 571 of the valve member 102 which is located adjacent to the first end 203 of the third passage 202 is profiled so that the end 571 is able to sealingly engage with the valve seat 194 when the valve member 102 is fully inserted into the first passage 190.

A plurality of O-ring seals 260 are mounted on the valve member 102 such that the seals 260 are able to form a seal between the valve member 102 and the valve body 101.

Attached to the valve body 101 are either valves 250 or pumps 573 for controlling the flow of fluid through the second passages of the valve body 101. The pumps 573 may for example be electromagnetic/electric over hydraulic pumps.

The valve body 101 is shown in FIG. 39 secured to a casing 574 of a well 575 so that the valve body 101 is able to function as a wellhead of the well 575. The valve body 101 is secured to the casing 574 such that the valve body 101 rests on a seabed 576.

The valve apparatus 570 also includes a clamp 571 for releasably securing the inserted valve member 102 to the valve body 101. The clamp 571 is located in the first passage 190 of the valve body 101 and includes a H4 locking system 572.

A fluid such as for example oil and/or gas that flows out of the well 575 is able to flow into the first passage 190 of the valve body 101 and then diverted to flow into the second passages, of the valve body 101 if the valve member 102 is open and does not seal off or blocked the second passages from the first passage 190.

If the valve member 102 is closed so that the valve member 102 seals off the second passages from the first passage 190, the fluid will flow through the first passage 190 of the valve body 101, and through the third passage 202 of the valve member 102 before leaving the valve apparatus 570.

If the valve apparatus 570 includes valves 250 and the valves 250 are open, the fluid that flows into the second passages is able to flow through the second passages and the valves 250. In a case where the valves 250 are closed, the fluid that flows into the second passages will not flow beyond those passages.

If the valve apparatus 570 includes pumps 573 and the pumps 573 are operating, the fluid that flows into the second passages will be pumped out of those passages by the pumps 573. Conversely, if the pumps 573 are not operating, they will not pump the fluid out of the second passages.

The valve member 102 may for example be part of a blowout preventer or stack that is supported by the valve body 101. The valve apparatus 570 may be braced or reinforced so that the apparatus 570, and particularly the valve body 101 of the apparatus 570, is able to support the weight of the blowout preventer or stack.

The valve apparatus 570 may be converted to become a diverter apparatus 580 by firstly removing the valve member 102 from the first passage 190 of the valve body 101, and then by securing a cap (not depicted) of the diverter apparatus 580 to the body 101 of the diverter apparatus 580 so that the cap seals the second end 192 of the first passage 190 and prevents fluid from the well 575 from flowing through the first passage 190 and out of the valve body 101.

If the valves 250 are open or the pumps 573 are operating, fluid that flows into the first passage 190 of the diverter apparatus 580 from the well 575 can be diverted to flow from the first passage 190 and into the second passages 193.

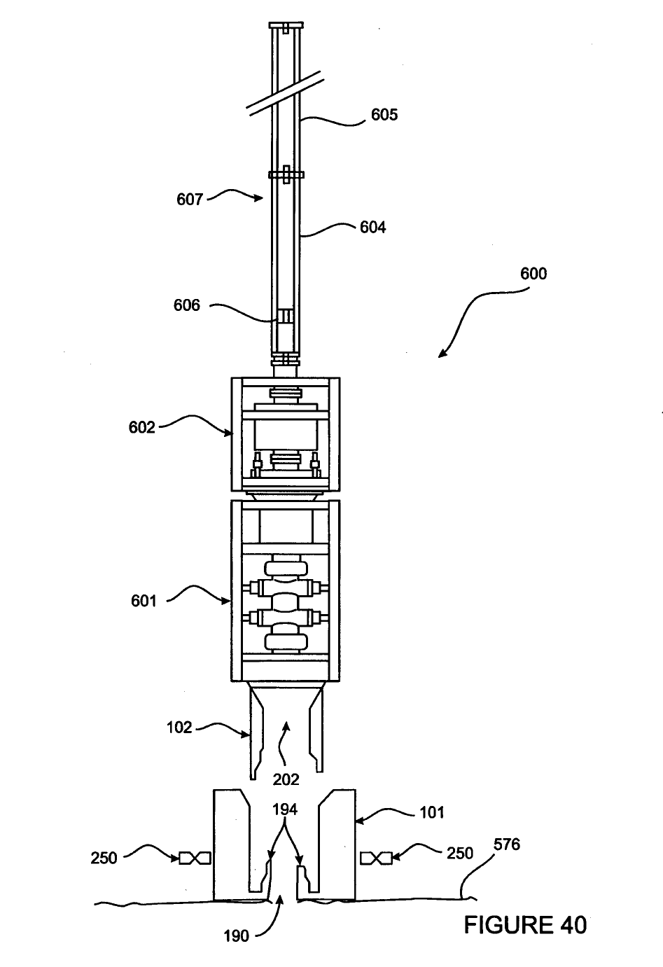

Referring to FIG. 40, a thirteenth preferred embodiment of a valve apparatus 600 is similar to the valve apparatus 570. The valve body 101 of the valve apparatus 600 rests on the seabed 576 and is secured or connected to a well (not depicted) such that a fluid that flows out of the well is able to flow into the first passage 190 of the valve body 101. The valve body 101 is connected to the well such that the valve body 101 is able to function or serve as a wellhead of the well.

The valve member 102 of the well apparatus 600 is able to be inserted into the first passage 190 of the valve body 101 and is able to be moved along the first passage 190 so that a lower end of the valve member 102 sealingly engages with the valve seat 194 of the valve body 101 and prevents fluid from the well from being diverted from the first passage 190 and flowing into the second passages (not depicted) that extend through the valve body 101 and laterally from the first passage 190.

Moving the valve member 102 along the first passage 190 so that the valve member 102 does not sealingly engage with the valve seat 194 allows fluid that flows into the first passage 190 from the well to flow from the first passage 190 and into each of the second passages. The flow of fluid through the second passages of the valve body 101 is able to be controlled by valves 250 that are connected to the valve body 101.

The valve apparatus 600 also includes a blowout preventer 601 that the valve member 102 is part of as can be seen in FIG. 40. As can be seen, the valve member 102 is located at the bottom of the blowout preventer 601.

In addition, the valve apparatus 600 includes a riser package 602 that is connected to the blowout preventer 601, and a riser string 603 that is connected to the riser package 602. The riser string 603 includes a first riser 604, and a second riser 605 that is connected to the first riser 604. In addition the riser string 603 includes a lower hinged clamped 606.

If the blowout preventer 601 and the lower riser package 602 fail, the valve member 102 can be removed from the first passage 190 by lifting the stack comprising the blowout preventer 601, lower riser package 602, and the riser string 603, and by opening the valves 250 so that the fluid that flows into the first passage 190 from the well is diverted to flow from the first passage 190 and through the second passages and the valves 250. Hoses or pipes (not depicted) that are connected to the valves 250 can safely transfer the fluid to a storage tank (not depicted) so that the fluid does not escape into the surrounding environment.

Even if the blowout preventer 601 and/or the riser package 602 have not failed, the valve apparatus 600 is still able to be operated in the above described manner so as to divert the flow of fluid from the well elsewhere without it escaping into the surrounding environment.

In a first alternative form, the valve member 102 is part of the riser package 602, and the valve body 101 may be connected or secured to the blowout preventer 601.

In a second alternative form, the valve member is part of the riser 604, and the valve body 101 may be connected or secured to the riser package 602.

In a third alternative form, the valve member 102 may be part of the riser 605, and the valve body 101 may be connected or secured to the riser 604.

It is also possible that the valve apparatus 600 can include multiple valve bodies 101 and multiple valve members 102 so that more than one of the aforementioned arrangements can be realised simultaneously.

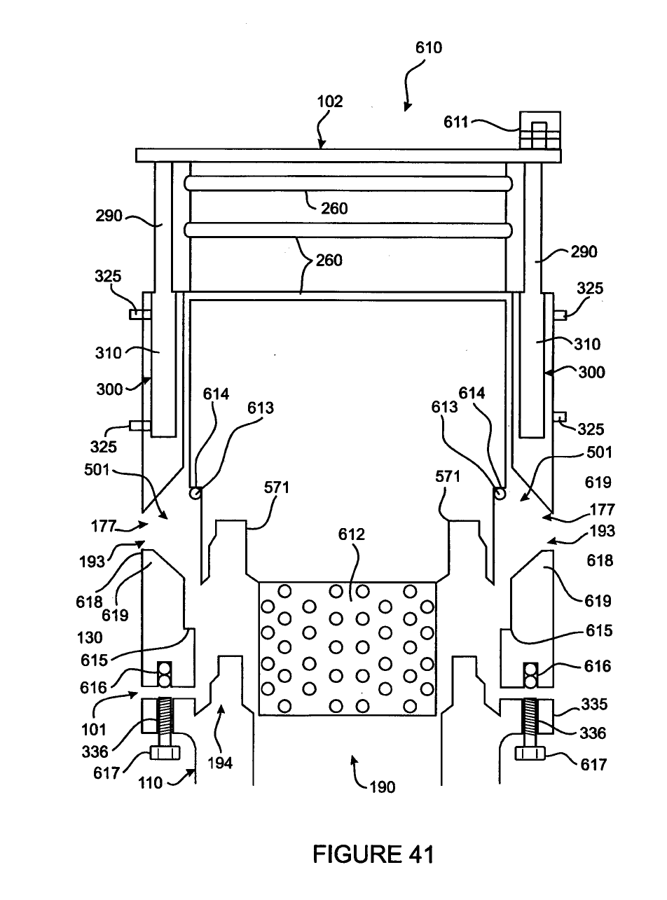

Referring to FIG. 41, there is shown a fourteenth preferred embodiment of a valve apparatus 610.

As with the previously described preferred embodiments, the valve apparatus 610 includes a valve body 101, and a valve member 102 that is inserted into a first passage 190 of the valve body 101. The valve member 102 is able to be moved relative to the valve body 101 so as to control the flow of a fluid from the first passage 190 into second passages 193 of the bodies 101.

A plurality of O-ring seals 260 are mounted on the valve member 102 such that the seals 260 are able to form a seal between the valve body 101 and the valve member 102. Alternatively, the valve member 102 can have a plurality of steel seats (not depicted) in place of the O-ring seals 260.

The valve apparatus 610 includes a plurality of hydraulic cylinders 300 that are built-in to the valve body 101 as shown so that the hydraulic cylinders 300 are effectively secured to the valve body 101. As can be seen, the valve body 101 forms the cylinder barrels 310 of the cylinders 300. A respective piston (not depicted) is slidably received in each barrel 300, and each piston is connected to a respective piston rod 290. The piston rod 290 of each cylinder 300 is able to be extended relative to the barrel 310 of the cylinder 300 by applying increased hydraulic pressure to a lower port 325 of the cylinder 300. Conversely, the piston rod 290 of each cylinder 300 is able to be retracted relative to the barrel 310 of the cylinder 300 by applying increased hydraulic pressure to an upper port 325 of the cylinder 300. Each piston rod 290 is secured to the valve member 102.

The piston rods 290 of the hydraulic cylinders 300 may be secured to the valve member 102 by shear pins 611 so that the valve member 102 is able to be released from the valve body 101 by breaking/shearing the shear pins 611.

Alternatively, the valve apparatus 610 may include a release mechanism (not depicted) that can be operated for example by a remotely operated vehicle or ROV (not depicted) so that the valve member 102 is released from the valve body 101 of the valve apparatus 610.

The valve member 102 can be lifted to such an extent that each shear pin 611 breaks and the valve member 102 is thereby released from the valve body 101. The lifting of the valve member 102 in this way can be accomplished in a number of ways. For example, the valve apparatus 610 may include a platform such as a well rig or vessel (not depicted) that is connected to the valve member 102 and that is operable to move the valve member 102 relative to the valve body 101. The valve member 102 may be moved relative to the valve body 101 by varying the buoyancy of the platform.

Another way in which the valve member 102 may be lifted relative to the valve body 101 so that the shear pins 611 break and the valve member 102 releases from the valve body 101 is by operating a tensioner such as a riser string tensioner that forms part of the valve apparatus 610 and that is connected to the valve member 102. The tensioner is operable to move the valve member 102 relative to the valve body 101.

The valve members 102 of the other valve apparatus herein described may be lifted from their valve bodies 101 in the same or a similar way so as to release the valve members 102 from the valve bodies 101.

Each second passage 193 of the valve apparatus 610 includes an inlet recess/opening 501, and an outlet opening 177 connected to the inlet recess 501.

The valve member 102 includes a profile the end 571 for engaging with a seat 194 of the valve body 101.

The valve member 102 also includes a diffuser 612 that is located at a lower end of the valve member 102 and that is able to protect at least one of the valve body 101 and the valve member 102 from wear. The diffuser 612 is able to protect the inside sleeve portion of the valve apparatus 610 from wear so that when the apparatus 610 is operated to cap a well that it is connected to, all of the various sealing faces of the valve apparatus 610 are protected.

The valve apparatus 610 also includes an O-ring seal 613 that is mounted on the valve member 102 such that the seal 613 is able to form a seal between the valve body 101 and the valve member 102. The valve member 102 includes a first shoulder 614, and the valve body includes a second shoulder 615. The seal 613 is supported on the first shoulder 614 and is able to engage with the second shoulder 615 when the valve member 102 is fully inserted into the first passage 190 so that the seal 613 thereby forms a seal between the valve member 102 and the valve body 101.

Mounting the O-ring seal 613 on the first shoulder 614 assists in preventing the seal 613 from being damaged as the valve member 102 and therefore the seal 613 passes the second passages 193 of the valve body 101

The valve body 101 includes a first part 110 that includes the valve seat 194, and a second part 130. The first part 110 includes a flange 335 that includes a plurality of holes 336. An end of the second part 130 includes a plurality of threaded bolt holes 616. The first part 110 and the second part 130 are secured together by aligning the holes 336 with the bolt holes 616, inserting bolts 617 through the holes 336, screwing the inserted bolts 617 into the bolt holes 616, and then tightening the bolts 617.

The valve body 101 includes a respective RTJ flange 618 surrounding each second passage outlet opening 177. Each flange 618 includes a plurality of threaded bolt holes 619. The bolt holes 619 can accept bolts or the fast connectors that are used in the oil and gas industry.

As with the valve apparatus 570, 600, the valve member 102 of the valve apparatus 610 may form part of blowout preventer, a riser package, riser, or some other component of a stack. Also, the valve body 101 may be connected directly to a well so that the valve body 101 is able to function as a wellhead, or the valve body 101 may be connected to a blowout preventer, riser package, riser, or some other component of a stack.

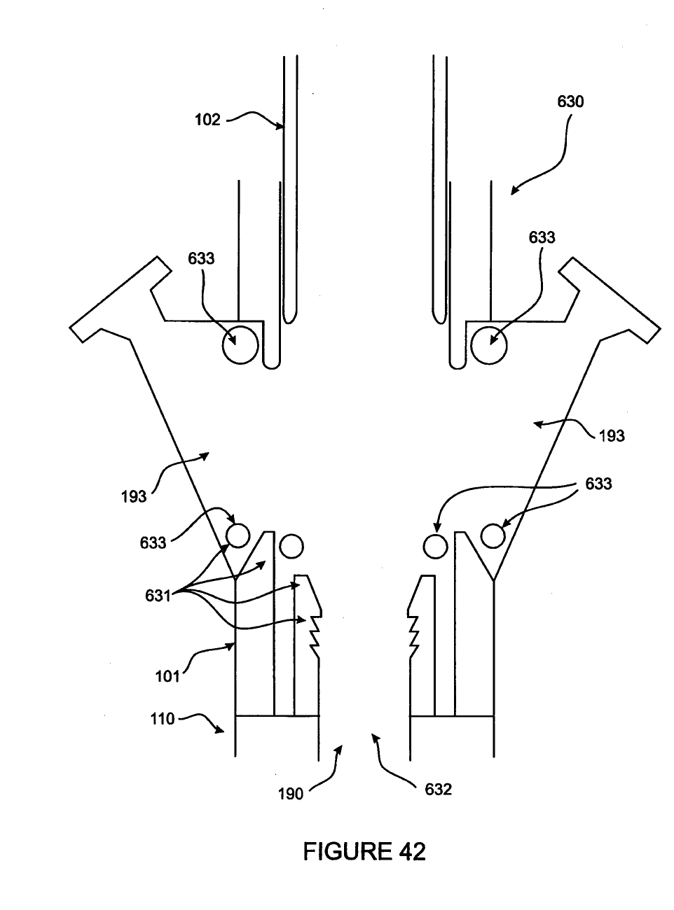

Referring to FIG. 42, there is shown a valve apparatus 630 according to a fifteenth preferred embodiment.

The valve body 101 of the valve apparatus 630 includes flow dynamic altering regions 631 that are able to alter the flow dynamics of a fluid 632 that flows through the first passage 190 of the valve body 101 so as to assist the fluid 632 to be diverted to flow from the first passage 190 and into and through each second passage 193 of the valve body 101.

The regions 631 are able to induce high and low pressure zones as well as turbulence 633 in the fluid 632.

The valve member 102 may be lifted from the valve body 101 by a sea vessel for example that is connected to the valve member 102. When the valve member 102 is lifted from the valve body 101 which may function as a wellhead, the valve member 102 and the valve body 101 are completely disconnected from each other.

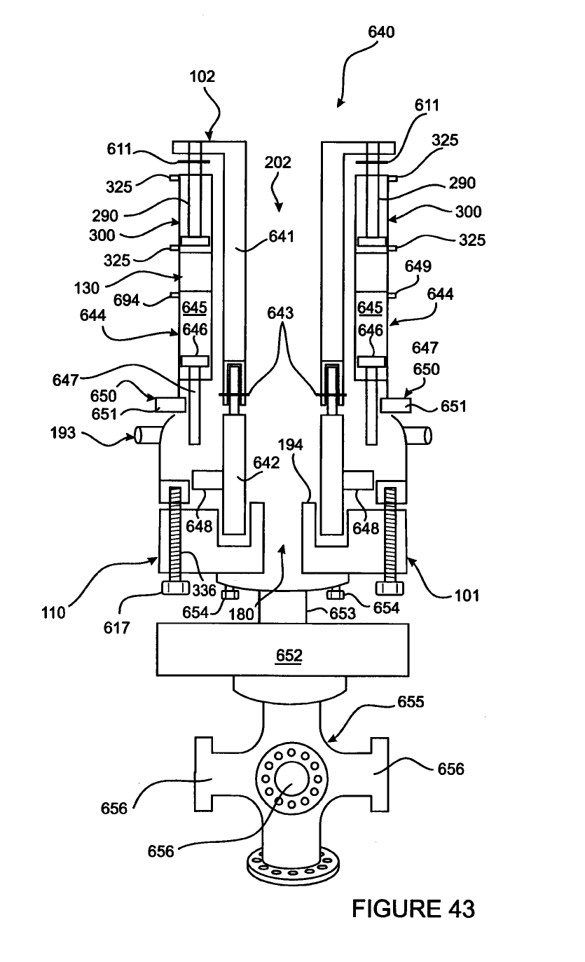

Referring to FIG. 43, there is depicted a sixteenth preferred embodiment of a valve apparatus 640.

The valve apparatus 640 includes a valve body 101 that includes a first passage 190 that extends through the valve body 101, and a plurality of second passages 193 that extend through the valve body 101 and laterally from the first passage 190.

The valve body 101 includes a first part 110, and a second part 130 that is secured to the first part 110. The first part 110 includes a plurality of holes 336 that extend through the first part 110. The second part 130 includes a plurality of threaded bolt holes 616. A plurality of bolts 617 are inserted into the holes 336, and are screwed into the bolt holes 616 so that the first part 110 is thereby secured to the second part 130.

In addition, the valve apparatus 640 includes a valve member 102 that is inserted into the first passage 190 of the valve body 101. The valve member 102 is able to be moved back and forth within the first passage 190 by a plurality of hydraulic cylinders 300 that are built-in to the valve body and that are of a similar construction to the cylinders 300 of the valve apparatus 610.

The piston rods 290 of the hydraulic cylinders 300 are secured to the valve member 102 by shear pins 611 that can be broken if a sufficient shear force is applied to them. Alternatively, the piston rods 290 may be secured to the valve member by sacrificial connecting studs (not depicted).

The hydraulic cylinders 300 are able to move the valve member 102 along the first passage 190 so that the valve member 105 sealingly engages with a valve seat 194 of the valve body 101. When the valve member 105 and valve seat 194 are sealingly engaged with each other, a fluid from a well that enters the first passage 190 is prevented by the valve member 102 from flowing into the second passages 193 from the first passage 190.

The hydraulic cylinders 300 are also able to move the valve member 102 along the first passage 190 so that the valve member 105 does not sealingly engage with the valve seat 194. When the valve member 102 is moved in this way, fluid from the well that enters the first passage 190 is able to flow from the first passage 190 into the second passages 193.

The valve member 102 includes an upper part 641 that is secured to the piston rods 290 of the hydraulic cylinders 300, and a lower part 642 that is secured to the upper part 641 by a plurality of shear pins 643. The shear pins 643 are able to be broken if a sufficient shear force is applied to them. The lower part 642 of the valve member 102 is able to be released from the upper part 641 of the valve member 102 by breaking each shear pin 643.

The valve apparatus 640 also includes a plurality of hydraulic cylinder pumps 644 that are, like the hydraulic cylinders 300, built-in to the valve body 101. Each pump 644 includes a barrel 645 that is part of the valve body 101, and a piston 646 that is received by the barrel 645 such that the piston 646 is able to slide back and forth within the barrel 645. Each pump 644 also includes a piston rod 647 that is secured to the piston 646 and that is able to be extended and retracted relative to the barrel 645 by sliding the piston 646 back and forth in the barrel 645.

The lower part 642 of the valve member 102 includes a flange 648 that the piston rods 647 are able to operatively engage with after the cylinders 300 have withdrawn the valve member 102 from the first passage 190 by a predetermined distance. This distance corresponds to a safe operating range of movement of the valve member 102 in which the valve apparatus 640 operates normally to allow or prevent fluid from flowing from the first passage 190 and into the second passages 193.

The pumps 644 are able to be operated by further withdrawing the valve member 102 from the first passage 190. The further withdrawal of the valve member 102 is able to be accomplished by lifting the valve member 102 using a vessel, well rig, tensioner, or some other lifting device that is connected to the valve member 102 and that is strong enough to lift the valve member 102. The valve member 102 may be connected to the lifting device, whatever it is, by a flex joint (not depicted) that is secured to the top of the upper part 641 of the valve member 102, and a riser (also not depicted) that is connected to the flex joint and the lifting device.

In the case where the lifting device is a string tensioner, the tensioner will probably need to be strengthened so that is able to handle the force necessary to shear the shear pins 611, 643, and to lift the valve member 102 out of the first passage 190 so that the valve member 102 clears the valve body 101.

The pumps 644 are operated by the flanges 648 of the lower part 642 forcing the piston rods 647 into the cylinder barrels 645. As the piston rods 647 are forced into the barrels 645, the pistons 646 force hydraulic fluid out of the barrels 645 through ports 649. The piston rods 647 are able to be forced further and further into the barrels 645 until the pistons 646 are unable to be moved any further along the barrels 645 (i.e. once the pistons 646 and piston rods 647 reach the top of their stroke). Once this point is reached, continued pulling on the valve member 102 in an attempt to withdraw it further from the first passage 190 will result in the shear pins 643 breaking or shearing and the lower part 642 thereby being released from the upper part 641. Once the shear pins 643 and the shear pins 611 break, the upper part 641 is completely released from the valve body 101 and can be completely removed from the valve body 101 by the lifting device.

The valve apparatus 640 also includes a plurality of hydraulically operated locks 645 that are operable by the pumps 644 to substantially maintain the position of the withdrawn and released lower part 642 relative to the valve body 101 so that it does not drop down into the lower part of the passage 190 and block fluid from flowing from the first passage into the second passages 193. In particular, the hydraulically operated locks 645 include locking pins 651 that are able to be operated by the pumps 644 so that the locking pins 651 engage with the lower part 642. The hydraulically operated locks 645 may only operate so that locking pins 651 engage with the flange 648 of the lower part 642 once the upper part 641 of the valve member 102 has been released from the valve body 101.

A blind shear ram 652 is operated by the pumps 644 so that the blind shear ram 652 seals a well bore of a well to which the valve apparatus 640 is connected so that fluid is thereby prevented from flowing into the first passage 190 of the valve body 101 from the wellbore. The blind shear ram 652 is connected to the valve body 101 by a joining adapter 653 that is secured to the first part 110 of the valve body 101 by a plurality of bolts 654 that are screwed into threaded bolt holes (not depicted) in the first part 110.

A pipe tee junction 655 connects the well to the valve body 101 via the blind shear ram 652. Before the wellbore is sealed by the blind shear ram 652, fluid from the well is able to flow through the junction 655 past the ram 652 and into the first passage 190 of the valve body 101. In addition, the fluid is able to flow into a plurality of lateral passages 656 of the pipe junction 655 so that the fluid can be diverted to flow through those lateral passages 656 and out of the pipe junction 655 after the wellbore has been sealed by the blind shear ram 652.

Hydraulically operated first valves (not depicted) are connected to the second passages 193, and hydraulically operated second valves (not depicted) are connected to the lateral passages 656 of the pipe junction 655. The pumps 644 operate the close the first valves and open the second valves so that fluid is able to be diverted to flow through the lateral passages 656 of the pipe junction 655. Simultaneously closing the first valves and opening the second valves in this manner is able to prevent the well from experiencing over-pressure which could damage the well and/or the geological formation that the well extends through and cause fluid (e.g. oil and/or gas) to leak uncontrollably from the well and/or formation.

Pipes or hoses (not depicted) that are connected to the lateral passages 656 are connected to storage tanks so that fluid can continue to flow from the well without escaping into the surrounding environment.

The valve apparatus 640 allows a platform such as a vessel or well rig for example that is floating above the well and that is connected to the well by the apparatus 640 to disconnect from the well in the event of an emergency (e.g. a well blowout) simply by pulling up on the valve member 102.

The valve apparatus 640 can be modified by dispensing with the pumps 644, flange 648, and the blind shear ram 652, and adding an internal shear ram (not depicted) that is operable to shear a pipe string that extends through the first passage 190 and the third passage 202. The internal shear ram 652 is operable to shear the pipe string as the valve member is withdrawn from the first passage 190. This modification not only removes the necessity for the blind shear ram 652, it also does away with the need to have particular gaskets, H4 connectors/locking systems, as well as other components.

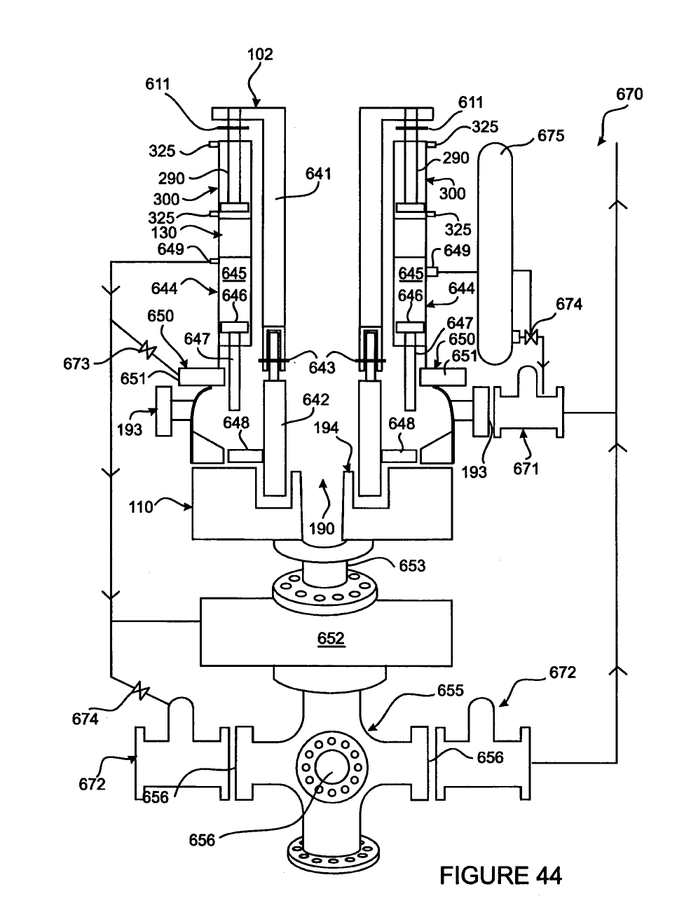

A seventeenth preferred embodiment of a valve apparatus 670 is illustrated in FIG. 44. The apparatus 670 is similar to the apparatus 640.

Hydraulically operated first valves 671 are shown connected to the second passages 193 of the valve body 101. Also, hydraulically operated second valves 672 are shown connected to the lateral passages 656 of the pipe junction 655. The first valves 671 and the second valves 672 are able to be operated by the pumps 644.

The apparatus 670 also includes high-pressure stop and lock valves 673 connecting the hydraulic pumps 644 to each hydraulically operated lock 650 so that the pumps 644 are able to operate the locks 650.

In addition, apparatus 670 includes in-line pressure stop valves 674 that connect the pumps 644 to each first valve 671 and to second valve 672 so that the pumps 644 are able to operate the first valves 671 and the second valves 672. The valves 674 lock off at a set pressure and hold the valves they are connected to open or closed as appropriate.

The valves 673, 674 enable the hydraulically operated locks 650, the first valves 671, and the second valves 672 to withstand the pressure output of the pumps 644 which needs to be sufficient enough to operate the blind shear ram 652. If the locks 650, first valves 671, and second valves 672 are able to withstand this pressure without the valves 673, 674, the valves 673, 674 can be omitted.

In one version of the apparatus 670 there is a bank of hydraulic accumulators 675 that connect the pumps 644 to the hydraulically operated locks 650, blind shear ram 652, and to the valves 671, 672. Employing the accumulators 675 is able to reduce the force that the tensioner (or other lifting device) must apply to the valve member 102 in order to release it from the valve body 101 and to also lift it clear from the valve body 101. Another option to reduce this force is to use sacrificial connectors such as the shear pins 611, 643 that are able to be broken/sheared more easily.

In an alternative version of the apparatus 670, there are no accumulators 675 so that there must be a sufficient volume of hydraulic fluid in the hydraulic circuit that includes the pumps 644 to drive valves 673, 674 (if present) and operate the hydraulically operated locks 650.

As with the apparatus 640, the first valves 671 are closed, and the second valves 672 are opened before the blind shear ram 652 is operated to seal the wellbore of the well.

The apparatus 670 may also include a four-way shear ram (not depicted), and a grab ram (not depicted) located beneath the pipe junction 655.

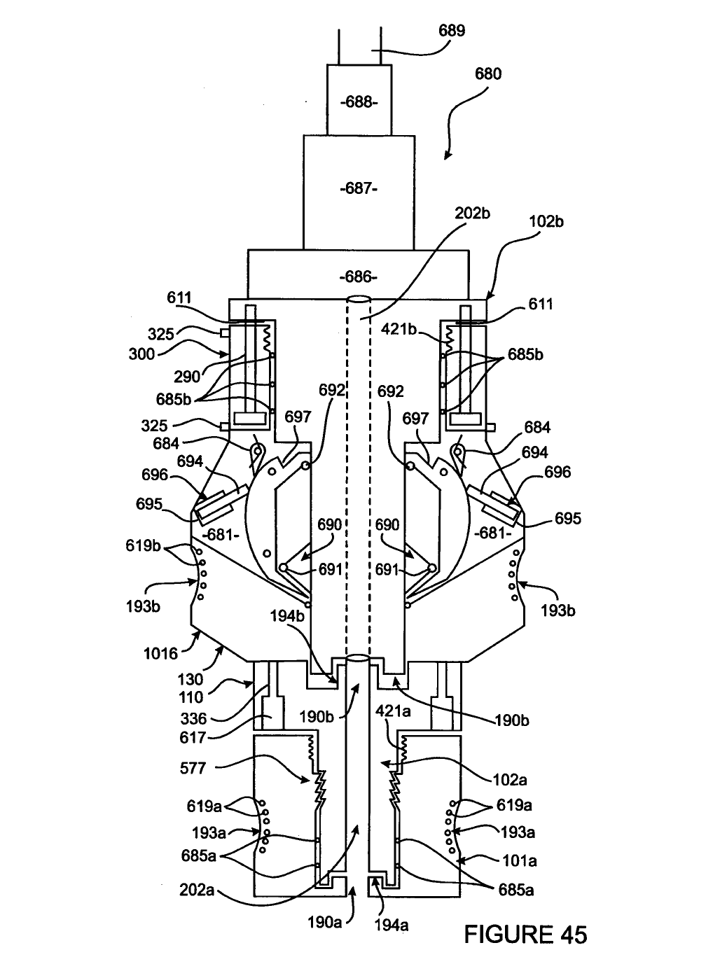

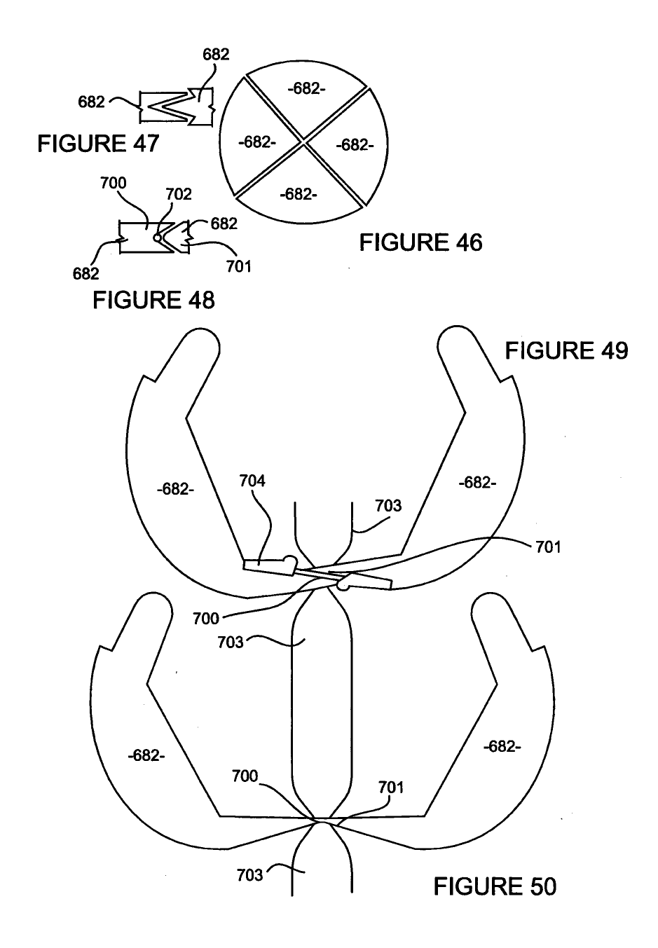

Referring to FIG. 45, there is illustrated an eighteenth preferred embodiment of a valve apparatus 680. The valve apparatus 680 is adapted to function as a blowout preventer.

Valve apparatus 680 includes a first valve body 101a that includes a first passage 190a that extends through the valve body 101a. The valve body 101a also includes a plurality of second passages 193a that extend through the valve body 101a and laterally from the first passage 190a so that a fluid that flows into the first passage 190a is able to flow from the first passage 190a and into each of the second passages 193a.

The valve body 101a may be connected to a well so that a fluid that flows from the well is able to flow into the first passage 190a. The valve body 101a may be connected to the well so that the valve body 101a is able to function as a wellhead of the well.

In addition to the valve body 101a, the valve apparatus 680 includes a first valve member 102a that is able to be inserted into the first passage 190a of the valve body 101a. The inserted valve member 102a is able to be moved relative to the first passage 190a. In particular the valve member 102a is able to be moved back and forth along the first passage 190a such that the flow of fluid from the first passage 190a and into the second passages 193a is thereby able to be controlled.

A lower end of the valve member 102a is able to engage with a valve seat 194a of the valve body 101a when the valve member 102a is fully inserted into the first passage 190a. This prevents fluid from flowing from the first passage 190a and into each of the second passages 193a. Consequently, the fluid will flow from the first passage 190a and through a third passage 202a of the valve member 102a.

If the lower end of the valve member 102a is not engaged with the valve seat 194a, fluid is able to flow from the first passage 190a and into each of the second passages 193a so that the flow of fluid through the first passage 190a and the third passage 202a is thereby diverted.

The valve apparatus 680 also includes a clamp 577 for securing the valve member 102a relative to the valve body 101a. The clamp 577 includes a H4 locking system.

Valve body 101a includes an internal thread 421a so that a valve body cap (not depicted) can be secured to the valve body 101a to seal an end of the first passage 190a and thereby prevent fluid from flowing through the first passage 190a and out of the valve body 101a. The valve body cap includes an external thread that is able to threadably engage with the internal thread 421a of the valve body 101a so that the valve body cap can then be secured to the valve body 101a by screwing it on to the valve body 101a.

The valve body 101a also includes a plurality of threaded bolt holes 619 located on the outside of the valve body 101a and around the second passages 193a. The bolt holes 619a allow attachments such as valves, pumps, hoses, pipes, and the like to be secured to the valve body 101a with a plurality of bolts that are screwed into the bolt holes 619a.

Valve apparatus 680 also includes a second valve body 101b. The second valve body 101b includes a first part 110 that is secured to or integrally formed with the first valve member 102a. In addition, the second valve body 101b includes a second part 130 that is secured to the first part 110 by a plurality of bolts 617 that are inserted into counter sunk holes 336 in the first part 110, and that are screwed into a plurality of internally threaded bolt holes (not depicted) in the second part 130.

A first passage 190b extends through both the first part 110 and the second part 130 of the second valve body 101b. A plurality of second passages 193b extend through the second part 130 of the second valve body 101b and laterally from the first passage 190b so that a fluid that flows into the first passage 190b is able to be diverted so that it flows from the first passage 190b and into the second passages 193b.

A second valve member 102b is inserted into the first passage 190b, and is able to be moved relative to the second valve body 101b by moving the second valve member 102b back and forth along the first passage 190b.

A lower end of the second valve member 102b is able to sealingly engage with a valve seat 194b of the second body 101b such that a fluid that flows into the first passage 190b is thereby prevented from flowing from the first passage 190b and into each of the second passages 193b.

If the second valve member 102b is raised or lifted relative to the second valve body 101b so that the second valve member 102b no longer sealingly engages with the valve seat 194b, fluid that enters the first passage 190b may flow from the first passage 190b into the second passages 193b.

The valve body 101b also includes a plurality of threaded bolt holes 619b that are located on the outside of the valve body 101b and around the second passages 193b. The bolt holes 619b allow attachments such as valves, pumps, hoses, pipes, and the like to be secured to the valve body 101b with a plurality of bolts that are screwed into the bolt holes 619b.

The second part 130 of the second valve body 102b defines one or more chambers 681 which contain a plurality of shear jaws 682 that are hinged to the second part 130 by pivots located at pivot/fulcrum points 683. The chambers 681 are filled with an appropriate fluid (e.g. oil) that is able to protect the shear jaws 682 from becoming blunt.

The chamber 681 can include any suitable number of shear jaws 682 from 2 shear jaws 682 on up.

A plurality of locking clips/pawls 684 are able to function as retainers to maintain the shear jaws 682 in the open position depicted in FIG. 45 until they are required to shear through a pipe that extends through a third passage 202b of the second valve member 102b and through the first passage 190b.

A plurality of hydraulic cylinders 300 are built-in to the second part 130 of the second valve body 101b. A piston rod 290 of each hydraulic cylinder 300 is secured to the second valve member 102b by a plurality of shear pins 611. The second valve member 102b can be released from the second valve body 101b by lifting the second valve member 102b until the shear pins 611 break/shear.

The hydraulic cylinders 300 are used to raise and lower the second valve member 102b relative to the second valve body 101b within a predetermined range or distance so as to control the flow of a fluid from the first passage 190b into the second passages 193b. The second valve member 102b can be raised and lowered in this manner without the shear pins 611 shearing. The second valve member 102b can be raised relative to the second valve body 101b by increasing the hydraulic pressure at lower ports 325 of the hydraulic cylinders 300 so that the hydraulic pressure at those ports exceeds the hydraulic pressure at upper ports 325 of the hydraulic cylinders 300. The second valve member 102b can be lowered relative to the second valve body 101b by increasing the hydraulic pressure at the upper ports 325 so that the hydraulic pressure at those ports exceeds the hydraulic pressure at the lower ports 325 of the hydraulic cylinders 300.

The second part 130 of the second valve body 101b includes an internal thread 421b so that upon removal of the second valve member 102b, a valve body cap (not depicted) can be secured to the second valve body 102b so as to seal an end of the first passage 190b. The valve body cap includes an external thread that is able to threadably engage with the internal thread 421b so that the valve body cap can be screwed on to the second valve body 102b such that the valve body cap is thereby secured to the second valve body 102b, and such that the valve body cap seals an end of the first passage 190b.

The first valve member 102a has a plurality of O-ring seals 685a mounted on it so that the seals 685a are able to form a seal between the first valve member 102a and the first valve body 101a. Likewise, the second valve member 102b has a plurality of O-ring seals 685b mounted on it so that the seals 685b are able to form a seal between the second valve member 102b and the second valve body 101b.

An upper portion 686 of the second valve member 102b is machined or otherwise configured so that it is able to accept various standard seals, connectors, and other components that are used in the oil and gas industries.

An annular blowout preventer 687 is connected to the upper portion 686 of the second valve member 102b. A flex joint 688 connects a riser 689 to the annular blowout preventer 687.

The second valve member 102b includes a plurality of cams 690 that include rollers 691 that engage with the shear jaws 682 as shown in FIG. 45 and thereby reduce friction between the cams 690 and the shear jaws 682 as the second valve member 102b moves relative to the cams 690.

Also, the shear jaws 682 include rollers 692 that engage with the second valve member 102b as shown in FIG. 45 and thereby reduce friction between the shear jaws 682 and the second valve member 102b as the second valve member 102b moves relative to the shear jaws 682.

In normal use, the valve apparatus 680 is connected to a well and a vessel or well rig is connected to the second valve member 102b. If there is an emergency (e.g. a well blowout) and the vessel or well rig consequently needs to disconnect from the well, the second valve member 102b is pulled upwardly so that the shear pins 611 are sheared and the second valve member 102b is thereby released from the second valve body 101b. The second valve member 102b can be pulled upwardly by a tensioner that is connected to the second valve member 102b and/or the buoyancy of the vessel/well rig can be increased so that the vessel/well rig as a whole pulls upwardly on the second valve member 102b.

As the second valve member 102b is withdrawn from the first passage 190b, the cams 690 move along the shear jaws 682 without causing the shear jaws 682 to pivot until the cams 690 approach the upper ends of the shear jaws 682. At this point the cams 690 operatively engage with the shear jaws 682 so that further withdrawal of the second valve member 102b from the first passage 190b causes the cams 690 to pivot the shear jaws 682 about their pivot points 683. As the shear jaws 682 pivot the upper ends of the jaws 682 move further apart from each other, while the lower ends of the jaws 682 move towards each other. The lower ends of the shear jaws 682 move towards each other so that they shear through the pipe that extends through the third passage of the second valve member 102b and the first passage 190b of the second valve body 101b.

As the shear jaws 682 pivot, pins 693 that extend from the shear jaws 682 eventually engage with the ends of piston rods 694 that extend from barrels 695 of hydraulic cylinders 696 that are secured to the second valve body 101b and located inside the chambers 681. The pins 693 push back on the piston rods 694 and force them in to the barrels 695. As the piston rods 694 are forced into the barrels 695, the opposing hydraulic force exerted on the piston rods 694 increases. Once the second valve member 102b has been withdrawn from the first passage 190b and no longer engages with the shear jaws 682, the opposing/restorative hydraulic force that is exerted on the piston rods 694 and which the rods 694 therefore exert on the pins 693 forces the pawls 684 to disengage from the notches 697 and the shear jaws 682 to pivot in the opposite direction until they return to their original position and are again secured in that position by the locking clips/pawls 684.

Once the shear jaws 682 have been pivoted to such an extent that the pawls 684 engage with notches 697 in the shear jaws 682, the pawls 684 inhibit further pivoting of the shear jaws 682.

The shear jaws 682 are not pivoted by the cams 690 until the lower end of the second valve member 102b has cleared the lower ends of the shear jaws 682 so that the shear jaws 682 can shear through the pipe without being obstructed by/shearing through the second valve member 102b. Thus, the second valve member 102b needs to be withdrawn from the first passage 190b by a predetermined distance so that further withdrawal of the second valve member 102b causes the cams 690 to pivot the shear jaws 682 so that the shear jaws 682 shear through the pipe.

Once the second valve member 102b has been lifted so that it no longer blocks the fluid from the well from passing from the first passage 190b and into the second passages 193b, the fluid is able to flow from the first passage 190b and into the second passages 193b. Although not depicted in FIG. 45, pipes and/or hoses may be connected to the second passages 193b so that the fluid that flows from the second passages 193 can be transferred through the pipes/hoses to a storage tank so that the fluid does not escape into the surrounding environment.

If need be, the second valve member 102b, second valve body 101b, and the first valve member 101a can be lifted out of the first valve body 101a after the clamp 577 is opened to release the first valve member 101a from the first valve body 101a. Once the first valve member 101a has been lifted sufficient from the first valve body 101a, fluid that flows into the first passage 190a of the first valve body 101a can be diverted to flow into the second passages 193 of the first valve body 101a from the first passage 190a. Hoses and/or pipes that are connected to the second passages 193a can transfer the fluid that flow from the second passages 193a to a storage tank so that the fluid does not escape into the surrounding environment.

The released second valve member 102b and upper portion of the sheared pipe can then be completely removed from the second valve body 101b so that the second valve member 102b is no longer connected to the well.

As mentioned above, the valve apparatus 680 can employ any suitable number of shear jaws 682 from 2 or 3 shear jaws 682 on up. FIG. 48 depicts a set of 4 shear jaws 682 that may be employed in the valve apparatus 680. The jaws 682 illustrated in FIG. 48 are shown in a closed position.

The shear jaws 682 may have various edge configurations. FIG. 47 depicts the profile of an edge 700 of a first shear jaw 682 and the profile of an edge 701 of a second shear jaw 682 which is engaged with the edge 700 of the first shear jaw 682. The edges 700, 701 function as steel seats that engage with each other as shown in FIG. 47 when the shear jaws 682 are closed.

FIG. 48 depicts the profile of an edge 700 of a first shear jaw 682 and the profile of an edge 701 of a second shear jaw 682 which is engaged with the edge 700. The edges 700, 701 have profiles that are similar to those depicted in FIG. 47. A rubber seal 702 extends along edge 700 as shown. When the shear jaws 682 are closed, the edges 700, 701 engage with each other such that the seal 702 is crushed between the edges 700, 701 and forms a seal between the edges 700, 701.

FIG. 49 depicts a pair of shear jaws 682 shearing through a pipe 703 of a well string. One of the shear jaws 682 has an edge 700 and the other one of the shear jaws 682 has an edge 701. The edges 700, 701 are steel edges that overlap with each other as shown as the shear jaws 682 shear through the pipe 703. A rubber seal 704 is secured to one of the shear jaws 682 as shown, and a rubber seal 705 is secured to the other one of the shear jaws 682 as shown. The seals 704, 705 are secured to the shear jaws 682 so that the edge 700 engages with the seal 705 and so that the edge 701 engages with the seal 704 as the shear jaws 682 shear through the pipe 703 and the edges 700, 701 overlap with each other. In this way, the seals 704, 705 form seals between the overlapping portions of the shear jaws 682.

FIG. 50 depicts a pair of shear jaws 682 shearing through the well string pipe 703. Steel edges 700, 701 of the shear jaws 682 eventually meet as the shear jaws 682 shear through the pipe 703. When the edges 700, 701 meet they sealingly engage with each other.

It will be appreciated by those skilled in the art that variations and modifications to the invention described herein will be apparent without departing from the spirit and scope thereof. The variations and modifications as would be apparent to persons skilled in the art are deemed to fall within the broad scope and ambit of the invention as herein set forth.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the term “substantially” or “about” will be understood to not be limited to the value for the range qualified by the terms.

It will be clearly understood that, if a prior art publication is referred to herein, that reference does not constitute an admission that the publication forms part of the common general knowledge in the art in Australia or in any other country.

1. A valve apparatus for a well, the apparatus comprising a valve body, and a valve member, the valve body including a first passage that extends through the valve body and that a pipe string is able to extend through, and at least one second passage that extends through the valve body and laterally from the first passage, the valve body being connectable to an outlet of the well so that a fluid flowing from the well outlet is able to flow into the first passage and into each second passage from the first passage, the valve member being insertable into the first passage and being moveable relative to the valve body so as to thereby control the flow of the fluid from the first passage into each second passage.

2. The valve apparatus of claim 1, wherein the second passage is inclined relative to the first passage.

3. The valve apparatus of claim 1, wherein the valve body also includes a valve seat for engaging with the valve member.

4. The valve apparatus of claim 1, wherein the valve apparatus also includes an O-ring seal mounted on the valve member such that the O-ring seal is able to form a seal between the valve body and the valve member.

5. The valve apparatus of claim 4, wherein the valve member includes a first shoulder, the valve body includes a second shoulder, and the O-ring seal is supported on the first shoulder and is able to engage with the second shoulder when the valve member is inserted into the first passage so that the O-ring seal thereby forms a seal between the valve member and the valve body.

6. The valve apparatus of claim 3, wherein the valve apparatus also includes a seal that is secured to a lower end of the valve member such that the seal is able to form a seal between the valve member and the valve seat.

7. The valve apparatus of claim 1, wherein the valve apparatus also includes an O-ring seal mounted on the valve body such that the seal is able to form a seal between a lower end of the valve member and the valve body.

8. The valve apparatus of claim 3, wherein the valve member includes a profiled end for engaging with the valve seat.

9. The valve apparatus of claim 1, wherein the valve member is able to be moved relative to the valve body by moving the valve member along the first passage.

10. The valve apparatus of claim 1, wherein the valve member includes a third passage that extends through the valve member such that the fluid is able to flow from the first passage and into the third passage.

11. The valve apparatus of claim 10, wherein the valve apparatus also includes a valve member cap for securing to the valve member such that an end of the third passage is sealed by the valve member cap.

12. The valve apparatus of claim 11 when dependent on claim 3, wherein the valve apparatus also includes a threaded shank fixedly secured to the valve member cap, a rod including an internally threaded end that the threaded shank is screwed in to such that the rod can be extended and retracted relative to the shank by rotating the shank relative to the rod, a flange secured to the rod and located adjacent an opposite end of the rod to the shank, and a seal supported by the flange, the valve seat including a recess for receiving the opposite end of the rod, the valve member cap being rotatable relative to the valve member such that the seal is able to sealingly engage the valve member and the valve seat and such that the opposite end of the rod is able to sealingly engage with the recess so that the fluid flowing into the first passage is thereby able to be prevented from flowing past the valve seat.

13. The valve apparatus of claim 1, wherein the valve body also includes at least one fourth passage extending through the valve body and laterally from the first passage so that at least some of the fluid that flows into the first passage is able to be diverted to flow from the first passage into each fourth passage, and the valve apparatus also including at least one fine shut down valve for controlling the flow of the fluid from each fourth passage.

14. The valve apparatus of claim 1, wherein the valve apparatus also includes at least one valve for controlling the flow of the fluid from each second passage.

15. The valve apparatus of claim 1, wherein the valve apparatus also includes a valve body cap for securing to the valve body such that an end of the first passage is sealed by the valve body cap.

16. The valve apparatus of claim 1, wherein the valve apparatus also includes a pipe cutter for cutting a pipe that extends through the first passage of the valve body and through the third passage of the valve member such that the pipe is able to be cut by the pipe cutter below each second passage into a bottom part and a top part, at least one lower grab ram for holding the bottom part of the cut pipe relative to the valve body, and at least one upper grab ram for holding the top part of the cut pipe relative to the valve member.

17. The valve apparatus of claim 16, wherein the valve apparatus also includes at least one shear ram for shearing the pipe.

18. The valve apparatus of claim 16, wherein the valve apparatus also includes a fold shear for capping the pipe.

19. The valve apparatus of claim 1, wherein, the valve apparatus also includes a lower frame for securing to the outlet of the well, and an upper frame for securing to the valve body, the lower frame including a plurality of upstanding posts, and the upper frame include a plurality of collars for receiving the upstanding posts such that the valve body is thereby able to be aligned with the outlet.

20. The valve apparatus of claim 10, wherein the valve apparatus also includes a valve operable to seal the third passage of the valve member.

21. The valve apparatus of claim 20, wherein the valve body is able to be connected to the well such that the valve body is able to function as a wellhead of the well.

22. The valve apparatus of claim 1, wherein the valve apparatus also includes a clamp for securing the valve member to the valve body.

23. The valve apparatus of claim 1, wherein the valve apparatus also includes at least one pump connected to each second passage.

24. The valve apparatus of claim 1, wherein the valve apparatus also includes a blowout preventer, and the valve member is part of the blowout preventer.

25. The valve apparatus of claim 24, wherein the valve apparatus also includes a riser package connected to the blowout preventer.

26. The valve apparatus of claim 25, wherein the valve apparatus also includes a riser connected to the riser package.

27. The valve apparatus of claim 1, wherein the valve apparatus also includes a riser package, and the valve member is part of the riser package.

28. The valve apparatus of claim 27, wherein the valve apparatus also includes a blowout preventer connected to the valve body.

29. The valve apparatus of claim 27, wherein the valve apparatus also includes a riser connected to the riser package.

30. The valve apparatus of claim 1, wherein the valve apparatus also includes a riser, and the valve member is part of the riser.

31. The valve apparatus of claim 30, wherein the valve apparatus also includes a riser package connected to the valve body.

32. The valve apparatus of claim 31, wherein the valve apparatus also includes a blowout preventer connected to the riser package.

33. The valve apparatus of claim 1, wherein the valve apparatus also includes a riser string that includes a plurality of interconnected risers, the valve member is part of one of the risers, and the valve body is connected to another one of the risers.

34. The valve apparatus of claim 33, wherein the valve apparatus also includes a riser package connected to one of the risers.

35. The valve apparatus of claim 34, wherein the valve apparatus also includes a hinged clamp that connects the riser package to the riser string.

36. The valve apparatus of claim 34, wherein the valve apparatus also includes a blowout preventer connected to the riser package.

37. The valve apparatus of claim 1, wherein the valve apparatus also includes at least one hydraulic cylinder secured to the valve body and to the valve member, each hydraulic cylinder being operable to move the valve member relative to the valve body.

38. The valve apparatus of claim 37, wherein each hydraulic cylinder is built-in to the valve body.

39. The valve apparatus of claim 37, wherein each hydraulic cylinder is secured to one of the valve body and the valve member by a sacrificial connector so that the valve member is able to be released from the valve body by breaking the sacrificial connector.

40. The valve apparatus of claim 39, wherein the sacrificial connector that secures each hydraulic cylinder to one of the valve body and the valve member is a shear pin.

41. The valve apparatus of claim 39, wherein the sacrificial connector that secures each hydraulic cylinder to one of the valve body and the valve member is a stud.

42. The valve apparatus of claim 1, wherein the valve member includes a diffuser that is located at a lower end of the valve member and that is able to protect at least one of the valve body and the valve member from wear.

43. The valve apparatus of claim 1, wherein the valve body also includes at least one flow dynamic altering region that is able to alter the flow dynamics of the fluid so as to assist the fluid to be diverted to flow from the first passage and into each second passage of the valve body.

44. The valve apparatus of claim 1, wherein the valve apparatus also includes a platform above the well, the platform being connected to the valve member and being operable to move the valve member relative to the valve body.

45. The valve apparatus of claim 44, wherein the platform is a vessel.

46. The valve apparatus of claim 44, wherein the platform is a well rig.

47. The valve apparatus of a claim 44, wherein the valve member is able to be moved relative to the valve body by varying the buoyancy of the platform.

48. The valve apparatus of claim 1, wherein the valve apparatus also includes a tensioner that is connected to the valve member and that is operable to move the valve member relative to the valve body.

49. The valve apparatus of claim 1, wherein the valve member includes an upper part and a lower part secured to the upper part by at least one sacrificial connector so that the lower part of the valve member is able to be released from the upper part of the valve member by breaking each sacrificial connector, the valve apparatus also includes at least one hydraulic pump that is able to operatively engage with the lower part after the valve member has been withdrawn from the first passage of the valve body by a predetermined distance and that is able to be operated by further withdrawing the valve member from the first passage so that each sacrificial connector breaks and the lower part releases from the upper part, at least one hydraulically operated lock that is operable by the pump to substantially maintain the position of the withdrawn and released lower part relative to the valve body, and a blind shear ram operable by the pump to seal a wellbore of the well.

50. The valve apparatus of claim 49, wherein each sacrificial connector that secures the lower part to the upper part is a shear pin.

51. The valve apparatus of claim 49, wherein each hydraulic pump is a hydraulic cylinder pump.

52. The valve apparatus of claim 49, wherein each hydraulically operated lock includes a locking pin for engaging with the lower part.

53. The valve apparatus of claim 49, wherein the valve apparatus also includes a pipe junction for diverting the fluid flowing from the well after the wellbore is sealed by the blind shear ram.

54. The valve apparatus of claim 49, wherein the valve apparatus also includes a flex joint connected to the valve member, and a riser connected to the flex joint.

55. The valve apparatus of claim 49, wherein the valve apparatus also includes at least one hydraulically operated first valve that is connected to each second passage and that is operable by the pump to control the flow of the fluid from each second passage, and at least one hydraulically operated second valve that is connected to the pipe junction and that is operable by the pump to control the flow of the fluid from a lateral passage of the pipe junction.

56. The valve apparatus of claim 49, wherein the valve apparatus also includes at least one valve connecting the hydraulic pump to each hydraulically operated lock.

57. The valve apparatus of any claim 49, wherein the valve apparatus also includes at least one valve connecting the pump to each first valve and to each second valve.

58. The valve apparatus of claim 55, wherein the valve apparatus also includes at least one hydraulic accumulator connected to the pump, the blind shear ram, each hydraulically operated lock, each first valve, and to each second valve.

59. The valve apparatus of claim 1, wherein the valve apparatus also includes a plurality of shear jaws that are hinged to the valve body and that are operable to shear through a pipe that is connected to the well and that extends through the first passage of the valve body, and the valve member includes a plurality of cams that are able to operably engage with the shear jaws after the valve member has been partially withdrawn from the first passage of the valve body such that the shear jaws are able to pivoted so that they shear through the pipe without shearing through the valve member and such that further withdrawal of the valve member causes the cams to pivot the shear jaws so that the shear jaws are able to shear through the pipe.

60. A method for controlling a fluid flowing from a well, the method comprising the steps of:
connecting the valve body of the apparatus of claim 1 to an outlet of the well so that the fluid flowing from the well outlet is able to flow into the first passage of the valve body and into each second passage of the valve body from the first passage; and
moving the valve member of the valve apparatus relative to the valve body so as to control the flow of the fluid into each second passage from the first passage.

61. The method of claim 60, wherein the step of moving the valve member relative to the valve body includes moving the valve member along the first passage.

62. A diverter apparatus for a well, the apparatus comprising a body, the body including a first passage that extends through the body and that a pipe string is able to extend through, and at least one second passage that extends through the body and laterally from the first passage, and a cap for securing to the body such that an end of the first passage is sealed by the cap, the body being connectable to an outlet of the well so that a fluid flowing from the well outlet is able to flow into the first passage and into each second passage from the first passage.

63. The diverter apparatus of claim 62, wherein each second passage is inclined relative to the first passage.

64. The diverter apparatus of claim 62, wherein the diverter apparatus also includes at least one valve for controlling the flow of the fluid from each second passage.

65. The diverter apparatus of claim 62, wherein the diverter apparatus also includes at least one pump connected to each second passage.

66-68. (canceled)
